(19) United States
(12) Patent Application Publication
(10) Pub. No.: US 2022/0058440 A1
(43) Pub. Date: Feb. 24, 2022

(54) LABELING AN UNLABELED DATASET

(71) Applicant: CHEVRON U.S.A. INC., San Ramon, CA (US)

(72) Inventors: Xin FENG, Houston, TX (US); Shuxing CHENG, Houston, TX (US); Tamas NEMETH, Houston, TX (US); Irene E. STEIN, Houston, TX (US); Larry A. BOWDEN JR., Houston, TX (US); Adam M. REEDER, Houston, TX (US)

(73) Assignee: CHEVRON U.S.A. INC., San Ramon, CA (US)

(21) Appl. No.: 17/410,400

(22) Filed: Aug. 24, 2021

Related U.S. Application Data
(60) Provisional application No. 63/069,220, filed on Aug. 24, 2020.

(51) Int. Cl. G06K 9/62; G06N 3/08

(52) U.S. Cl. CPC G06K 9/6259; G06N 3/08; G06K 9/6263; G06K 9/6202

(57) ABSTRACT

Embodiments of labeling an unlabeled dataset are provided. One embodiment comprises (a) obtaining a labeled dataset comprising a first plurality of data inputs and corresponding labels; (b) training a classification model using the labeled dataset; (c) obtaining the unlabeled dataset comprising a second plurality of data inputs without labels; (d) applying the classification model to the unlabeled dataset to generate a predicted label for each data input of the unlabeled dataset; (e) determining a verification quantity of the predicted labels to be verified by a user; (f) obtaining a verification dataset for the verification quantity of the predicted labels verified by the user; (g) updating the classification model using the verification dataset; and (h) applying the updated classification model to the remaining predicted labels that did not undergo verification and updating in response to the updated classification model. The verification dataset comprises an update to at least one predicted label.

### CROSS REFERENCES TO RELATED APPLICATIONS

The application claims the benefit of U.S. Provisional Application No. 63/069,220 filed Aug. 24, 2020, which is hereby incorporated by reference in its entirety.

### STATEMENT REGARDING FEDERALLY SPONSORED RESEARCH OR DEVELOPMENT

Not applicable.

### TECHNICAL FIELD

The disclosed embodiments relate generally to techniques for labeling an unlabeled dataset.

### BACKGROUND

Labeled samples are the foundation of many machine learning/artificial intelligence (AI) work, including but not limited to, classification, segmentation, and regression. For example, large labeled datasets are fundamental to the success of supervised machine learning projects. However, generation of large labeled datasets is usually prohibitively expensive due to various factors: inaccessibility to domain expert knowledge, high unit cost to generate raw data, and others.

In the hydrocarbon industry, while it is typically affordable to generate large amounts of unlabeled datasets, the efforts to label features is still difficult. For example, it is often difficult to determine how much input data to label in order to train a model, such as a machine learning model. Oftentimes, an arbitrary percentage of samples is labeled or a certain percentage is periodically labeled. If the arbitrary percentage is too low, then the accuracy of the machine learning model may be negatively impacted. If the arbitrary percentage is too high, then one or more SME's may spend unnecessary time labeling input data. Moreover, if the dataset quality is low, then the machine learning model may simply fail. Other downsides of conventional approaches include the following: not scalable, typically not able to manage the machine learning model, typically not able to swap out the machine learning model, and/or typically not able to reduce SME time except by changing the arbitrary values to other arbitrary values.

There exists a need for an improved manner of labeling an unlabeled dataset.

### SUMMARY

Embodiments of labeling an unlabeled dataset are provided herein.

One embodiment of a method for labeling an unlabeled dataset is provided herein. The embodiment comprises: (a) obtaining a labeled dataset comprising a first plurality of data inputs and corresponding labels; (b) training a classification model using the labeled dataset; (c) obtaining the unlabeled dataset comprising a second plurality of data inputs without corresponding labels; (d) applying the classification model to the unlabeled dataset to generate a predicted label for each data input of the unlabeled dataset; (e) determining a verification quantity of the predicted labels to be verified by a user; and (f) obtaining a verification dataset for the determined verification quantity of the predicted labels verified by the user. The verification dataset comprises an update to at least one predicted label generated by the classification model. The embodiment further comprises (g) updating the classification model using the verification dataset; and (h) applying the updated classification model to the remaining predicted labels that did not undergo verification and updating the remaining predicted labels in response to the updated classification model.

One embodiment of a system for labeling an unlabeled dataset is provided herein. The embodiment comprises a processor and a non-transitory computer readable medium with computer executable instructions embedded thereon. The computer executable instructions configured to cause the processor to: (a) obtain a labeled dataset comprising a first plurality of data inputs and corresponding labels; (b) train a classification model using the labeled dataset; (c) obtain the unlabeled dataset comprising a second plurality of data inputs without corresponding labels; (d) apply the classification model to the unlabeled dataset to generate a predicted label for each data input of the unlabeled dataset; (e) determine a verification quantity of the predicted labels to be verified by a user; and (f) obtain a verification dataset for the determined verification quantity of the predicted labels verified by the user. The verification dataset comprises an update to at least one predicted label generated by the classification model. The embodiment further comprises (g) update the classification model using the verification dataset; and (h) apply the updated classification model to the remaining predicted labels that did not undergo verification and update the remaining predicted labels in response to the updated classification model.

One embodiment of a non-transitory computer readable medium storing one or more programs is provided herein. The one or more programs comprise instructions, which when executed by an electronic device with one or more processors and memory, cause the device to: (a) obtain a labeled dataset comprising a first plurality of data inputs and corresponding labels; (b) train a classification model using the labeled dataset; (c) obtain the unlabeled dataset comprising a second plurality of data inputs without corresponding labels; (d) apply the classification model to the unlabeled dataset to generate a predicted label for each data input of the unlabeled dataset; (e) determine a verification quantity of the predicted labels to be verified by a user; and (f) obtain a verification dataset for the determined verification quantity of the predicted labels verified by the user. The verification dataset comprises an update to at least one predicted label generated by the classification model. The embodiment further comprises (g) update the classification model using the verification dataset; and (h) apply the updated classification model to the remaining predicted labels that did not undergo verification and update the remaining predicted labels in response to the updated classification model.

### DESCRIPTION OF THE DRAWINGS

FIG. 1A illustrates a diagram of one embodiment of a system configured for labeling an unlabeled dataset, in accordance with one or more implementations.

FIG. 1B illustrates an example computing system that may be used in implementing various features of embodiments of the disclosed technology.

FIG. 1C illustrates a diagram of one embodiment of a system architecture consistent with the instant disclosure, including a data layer, an algorithmic layer, and a presentation layer.

FIG. 2A illustrates an embodiment of a method of labeling an unlabeled dataset.

FIGS. 2B-2C illustrate another embodiment of a method of labeling an unlabeled dataset.

FIGS. 3A-3N illustrate one embodiment of a tool for labeling an unlabeled dataset.

FIGS. 4A-4J illustrate another embodiment of a tool for labeling an unlabeled dataset.

FIGS. 5A-5D illustrate diagrams for Test 1, which involved classification of 13,000 events using a workflow as discussed herein with nine iterations.

FIGS. 6A-6D illustrate diagrams for Test 2, which involved classification of 6,500 events using a workflow as discussed herein with eleven iterations.

Various embodiments and examples are provided in the figures. Reference will now be made in detail to various embodiments, where like reference numerals designate corresponding parts throughout the several views. In the following detailed description, numerous specific details are set forth in order to provide a thorough understanding of the present disclosure and the embodiments described herein. However, embodiments described herein may be practiced without these specific details. In other instances, well-known methods, procedures, components, and mechanical apparatuses have not been described in detail so as not to unnecessarily obscure aspects of the embodiments.

### DETAILED DESCRIPTION

TERMINOLOGY: The following terms will be used throughout the specification and will have the following meanings unless otherwise indicated.

Formation: Hydrocarbon exploration processes, hydrocarbon recovery (also referred to as hydrocarbon production) processes, or any combination thereof may be performed on a formation. The formation refers to practically any volume under a surface. For example, the formation may be practically any volume under a terrestrial surface (e.g., a land surface), practically any volume under a seafloor, etc. A water column may be above the formation, such as in marine hydrocarbon exploration, in marine hydrocarbon recovery, etc. The formation may be onshore. The formation may be offshore (e.g., with shallow water or deep water above the formation). The formation may include hydrocarbons, such as liquid hydrocarbons (also known as oil or petroleum), gas hydrocarbons (e.g., natural gas), solid hydrocarbons (e.g., asphaltenes or waxes), a combination of hydrocarbons (e.g., a combination of liquid hydrocarbons and gas hydrocarbons) (e.g., a combination of liquid hydrocarbons, gas hydrocarbons, and solid hydrocarbons), etc. The formation may include faults, fractures, overburdens, underburdens, salts, salt welds, rocks, sands, sediments, pore space, etc. Indeed, the formation may include practically any geologic point(s) or volume(s) of interest (such as a survey area) in some embodiments. One or more seismic images may generated for the formation or portion of the formation. The terms “formation”, “subsurface formation”, “hydrocarbon-bearing formation”, “reservoir”, “subsurface reservoir”, “subsurface region of interest”, “subterranean reservoir”, “subsurface volume of interest”, “subterranean formation”, and the like may be used synonymously. The terms “formation”, “hydrocarbons”, and the like are not limited to any description or configuration described herein.

Wellbore/Surface Facility: The formation may also include at least one wellbore. For example, at least one wellbore may be drilled into the formation in order to confirm the presence of the hydrocarbons. As another example, at least one wellbore may be drilled into the formation in order to recover (also referred to as produce) the hydrocarbons. A wellbore refers to a single hole, usually cylindrical, that is drilled into the formation for hydrocarbon exploration, hydrocarbon recovery, surveillance, or any combination thereof. The wellbore is usually surrounded by the formation and the wellbore may be configured to be in fluidic communication with the formation (e.g., via perforations). The wellbore may have straight, directional, or a combination of trajectories. For example, the wellbore may be a vertical wellbore, a horizontal wellbore, a multilateral wellbore, an inclined wellbore, a slanted wellbore, etc. The wellbore may be used for injection (referred to as an injection wellbore) in some embodiments. The wellbore may be used for production (referred to as a production wellbore) in some embodiments. A plurality of wellbores (e.g., tens to hundreds of wellbores) are often used in a field to recover hydrocarbons.

The wellbore may include a plurality of components, such as, but not limited to, a casing, a liner, a tubing string, a heating element, a sensor, a packer, a screen, a gravel pack, artificial lift equipment (e.g., an electric submersible pump (ESP)), gauges, sensors, valves, other instruments, or other equipment. The “casing” refers to a steel pipe cemented in place during the wellbore construction process to stabilize the wellbore. The “liner” refers to any string of casing in which the top does not extend to the surface but instead is suspended from inside the previous casing. The “tubing string” or simply “tubing” is made up of a plurality of tubulars (e.g., tubing, tubing joints, pup joints, etc.) connected together. The tubing string is lowered into the casing or the liner for injecting a fluid into the formation, producing a fluid from the formation, or any combination thereof. The casing may be cemented in place, with the cement positioned in the annulus between the formation and the outside of the casing. The wellbore may also include any completion hardware that is not discussed separately. If the wellbore is drilled offshore, the wellbore may include some of the previous components plus other offshore components, such as a riser.

The wellbore may also include equipment to control fluid flow into the wellbore, control fluid flow out of the wellbore, or any combination thereof. For example, each wellbore may include a wellhead, a BOP, chokes, valves, or other control devices. These control devices may be located on the surface, under the surface (e.g., downhole in the wellbore), or any combination thereof. In some embodiments, the same control devices may be used to control fluid flow into and out of the wellbore. In some embodiments, different control devices may be used to control fluid flow into and out of the wellbore. The control devices may also be utilized to control the pressure profile of the wellbore.

The wellbore may be drilled into the formation using practically any drilling technique and equipment known in the art, such as geosteering, directional drilling, etc. Drilling the wellbore may include using a tool, such as a drilling tool that includes a drill bit and a drill string. Drilling fluid, such as drilling mud, may be used while drilling in order to cool the drill tool and remove cuttings. Other tools may also be used while drilling or after drilling, such as measurement-while-drilling (MWD) tools, seismic-while-drilling (SWD) tools, wireline tools, logging-while-drilling (LWD) tools, or other downhole tools. After drilling to a predetermined depth, the drill string and the drill bit are removed, and then the casing, the tubing, etc. may be installed according to the design of the wellbore.

In some embodiments, the rate of flow of fluids through the wellbore may depend on the fluid handling capacities of a surface facility that is in fluidic communication with the wellbore. For example, the wellbore may be in fluidic communication with the surface, such as a surface facility on the surface, to process the produced fluid (including hydrocarbons) from the wellbore. The surface facility may include oil/gas/water separators, gas compressors, storage tanks, pumps, blenders, gauges, sensors, meters, pipelines, control systems, power systems, valves, heat exchangers, coolers, mixers, other instruments, or other equipment.

The term “wellbore” may be used synonymously with the terms “borehole,” “well,” or “well bore.” The terms “wellbore” and ‘surface facility” are not limited to any description or configuration described herein.

Hydrocarbon recovery: The hydrocarbons may be recovered (sometimes referred to as produced) from the formation using primary recovery (e.g., by relying on pressure to recover the hydrocarbons), secondary recovery (e.g., by using water injection (also referred to as waterflooding) or natural gas injection to recover hydrocarbons), enhanced oil recovery (EOR), or any combination thereof. The hydrocarbons may be recovered from the formation using a fracturing process. For example, a fracturing process may include fracturing using electrodes, fracturing using fluid (oftentimes referred to as hydraulic fracturing), etc. The hydrocarbons may be recovered from the formation using radio frequency (RF) heating. Another hydrocarbon recovery process(s) may also be utilized to recover the hydrocarbons. This is not an exhaustive list of hydrocarbon recovery processes. Each hydrocarbon recovery process may be associated with particular instruments, equipment, etc.

Other definitions: The terms “comprise” (as well as forms, derivatives, or variations thereof, such as “comprising” and “comprises”) and “include” (as well as forms, derivatives, or variations thereof, such as “including” and “includes”) are inclusive (i.e., open-ended) and do not exclude additional elements or steps. For example, the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Accordingly, these terms are intended to not only cover the recited element(s) or step(s), but may also include other elements or steps not expressly recited. Furthermore, as used herein, the use of the terms “a” or “an” when used in conjunction with an element may mean “one,” but it is also consistent with the meaning of “one or more,” “at least one,” and “one or more than one.” Therefore, an element preceded by “a” or “an” does not, without more constraints, preclude the existence of additional identical elements.

The use of the term “about” applies to all numeric values, whether or not explicitly indicated. This term generally refers to a range of numbers that one of ordinary skill in the art would consider as a reasonable amount of deviation to the recited numeric values (i.e., having the equivalent function or result). For example, this term can be construed as including a deviation of ±10 percent of the given numeric value provided such a deviation does not alter the end function or result of the value. Therefore, a value of about 1% can be construed to be a range from 0.9% to 1.1%. Furthermore, a range may be construed to include the start and the end of the range. For example, a range of 10% to 20% (i.e., range of 10%-20%) includes 10% and also includes 20%, and includes percentages in between 10% and 20%, unless explicitly stated otherwise herein. Similarly, a range of between 10% and 20% (i.e., range between 10%-20%) includes 10% and also includes 20%, and includes percentages in between 10% and 20%, unless explicitly stated otherwise herein.

The term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

It is understood that when combinations, subsets, groups, etc. of elements are disclosed (e.g., combinations of components in a composition, or combinations of steps in a method), that while specific reference of each of the various individual and collective combinations and permutations of these elements may not be explicitly disclosed, each is specifically contemplated and described herein. By way of example, if an item is described herein as including a component of type A, a component of type B, a component of type C, or any combination thereof, it is understood that this phrase describes all of the various individual and collective combinations and permutations of these components. For example, in some embodiments, the item described by this phrase could include only a component of type A. In some embodiments, the item described by this phrase could include only a component of type B. In some embodiments, the item described by this phrase could include only a component of type C. In some embodiments, the item described by this phrase could include a component of type A and a component of type B. In some embodiments, the item described by this phrase could include a component of type A and a component of type C. In some embodiments, the item described by this phrase could include a component of type B and a component of type C. In some embodiments, the item described by this phrase could include a component of type A, a component of type B, and a component of type C. In some embodiments, the item described by this phrase could include two or more components of type A (e.g., A1 and A2). In some embodiments, the item described by this phrase could include two or more components of type B (e.g., B1 and B2). In some embodiments, the item described by this phrase could include two or more components of type C (e.g., C1 and C2). In some embodiments, the item described by this phrase could include two or more of a first component (e.g., two or more components of type A (A1 and A2)), optionally one or more of a second component (e.g., optionally one or more components of type B), and optionally one or more of a third component (e.g., optionally one or more components of type C). In some embodiments, the item described by this phrase could include two or more of a first component (e.g., two or more components of type B (B1 and B2)), optionally one or more of a second component (e.g., optionally one or more components of type A), and optionally one or more of a third component (e.g., optionally one or more components of type C). In some embodiments, the item described by this phrase could include two or more of a first component (e.g., two or more components of type C (C1 and C2)), optionally one or more of a second component (e.g., optionally one or more components of type A), and optionally one or more of a third component (e.g., optionally one or more components of type B).

This written description uses examples to disclose the invention, including the best mode, and also to enable any person skilled in the art to make and use the invention. The patentable scope is defined by the claims, and may include other examples that occur to those skilled in the art. Such other examples are intended to be within the scope of the claims if they have elements that do not differ from the literal language of the claims, or if they include equivalent elements with insubstantial differences from the literal language of the claims.

Unless defined otherwise, all technical and scientific terms used herein have the same meanings as commonly understood by one of skill in the art to which the disclosed invention belongs. All citations referred herein are expressly incorporated by reference.

OVERVIEW: The embodiments provided herein utilize a verification quantity for the predicted labels generated by the classification model (e.g., machine learning model (aka artificial intelligence model)) to be verified by a user. The verification quantity removes the guess work and avoids having to arbitrarily select arbitrary percentages or other fixed values. For example, some of the embodiments provided herein may include: determining a verification quantity of the predicted labels to be verified by a user (e.g., using an AQL algorithm alone or the AQL algorithm in combination with at least one other algorithm to determine the verification quantity); obtaining a verification dataset for the determined quantity of the predicted labels verified by the user, updating the classification model using the verification dataset; and applying the updated classification model to the remaining predicted labels that did not undergo verification and updating the remaining predicted labels in response to the updated classification model. The verification dataset comprises an update to at least one predicted label generated by the classification model.

Advantageously, a SME may spend less time labeling data input and the SME's time may be utilized for efficiently based on embodiments consistent with the instant disclosure. For example, the expected time savings may be up to 70% in data labeling time and up to 40% in workflow time. Moreover, 90% or greater accuracy in predicting labels may also be achieved in some embodiments. As illustrated in the Tests 1-2 in the figures, the unlabeled dataset may be labeled in a much faster manner with embodiments consistent with the instant disclosure. Embodiments consistent with the instant disclosure may be utilized to efficiently make datasets ready for machine learning-based applications across the enterprise.

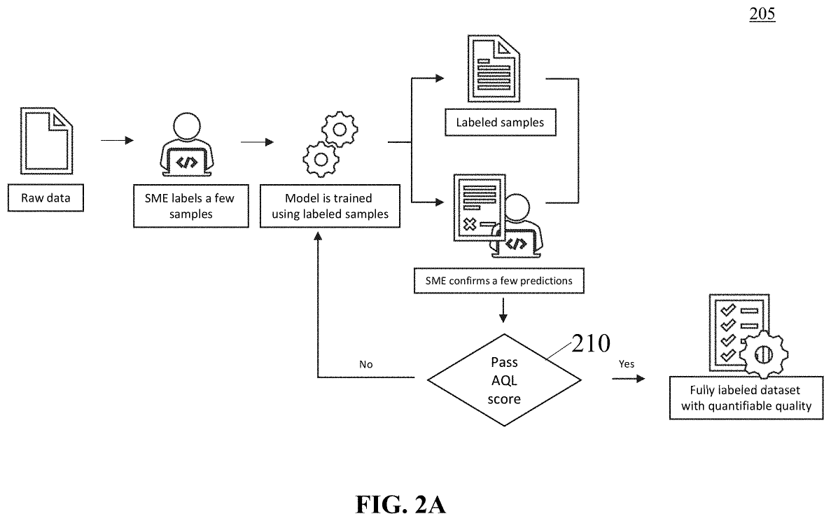

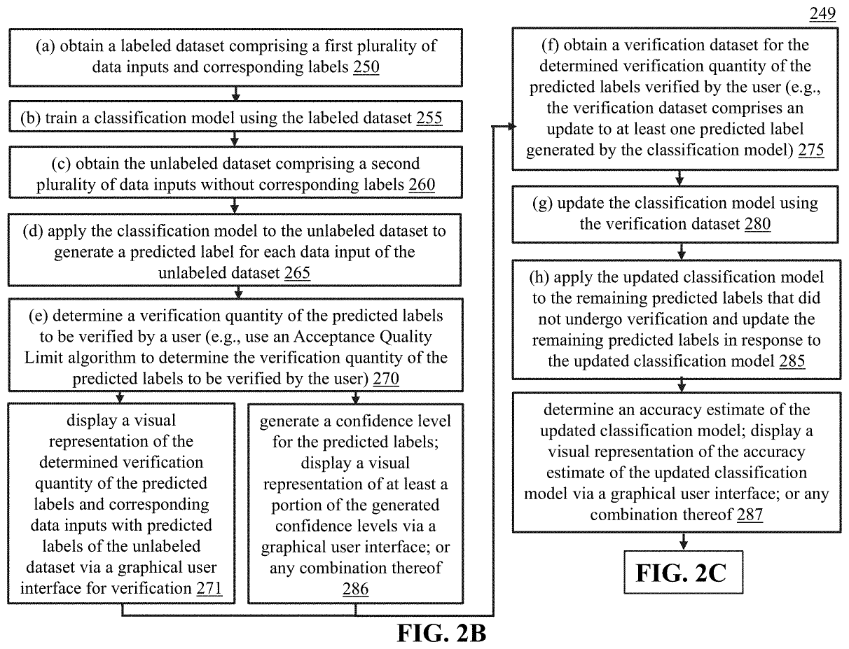

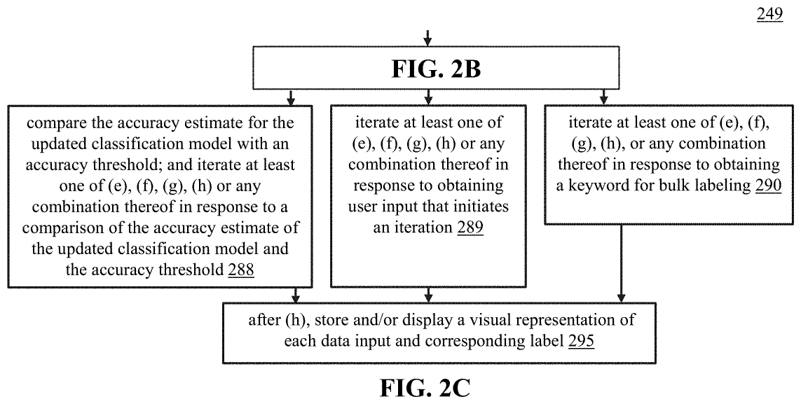

Advantageously, embodiments consistent with the instant disclosure are scalable. Some embodiments provide scaling dataset labeling by incorporating user input and machine learning. The keyword option for bulk labeling also assists with the scaling. The iterations also assist with the scaling. Regarding iterations, the method of FIG. 2B-2C may be run once in some embodiments, but one or more steps may be repeated/iterated in some embodiments. Indeed, embodiments consistent with the instant disclosure may enable agile and scalable processes, especially as labeling and classifying unstructured datasets is foundational to modeling a variety of machine learning activities.

Advantageously, the classification model may also be switched out for different contexts, in other words, plug-and-play of the underlying classification model (e.g., machine learning/AI Model). Indeed, embodiments consistent with the instant disclosure may be applied to images, audios, or other types of unstructured data. For example, an unlabeled dataset related to instrument events, equipment events, maintenance events, weather events, etc. may be labeled as illustrated in the figures. As another example, unlabeled dataset related to seismic images may be labeled. As another example, unlabeled dataset related to document retention may be labeled, as keep, delete, or postpone. Furthermore, business unit specific workflows may be built.

Advantageously, the labels may also be applied more consistently, which may lead in an increase in the accuracy of the classification model.

Advantageously, embodiments consistent with the instant disclosure may be utilized to remove barriers typically caused by lack of dataset labels and mitigate the “data cold start” problem to drive business value.

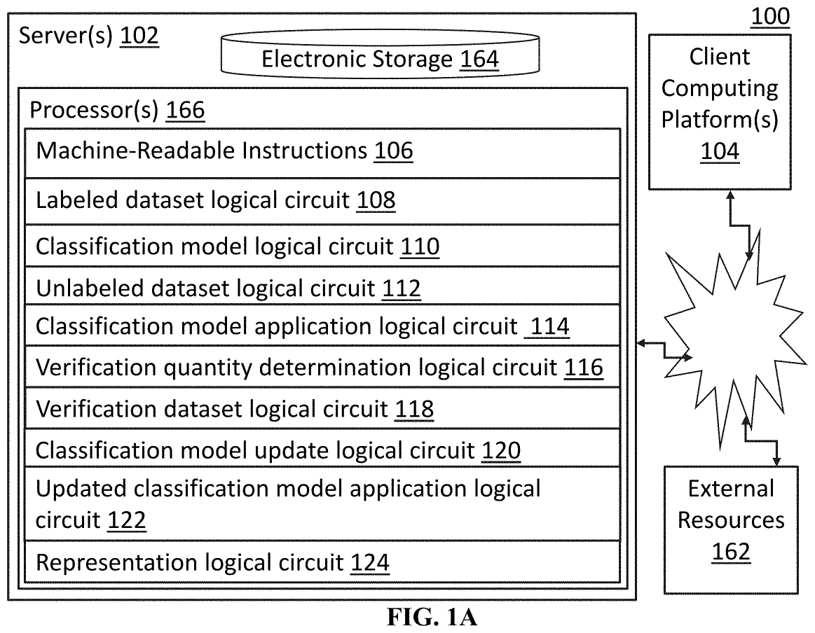

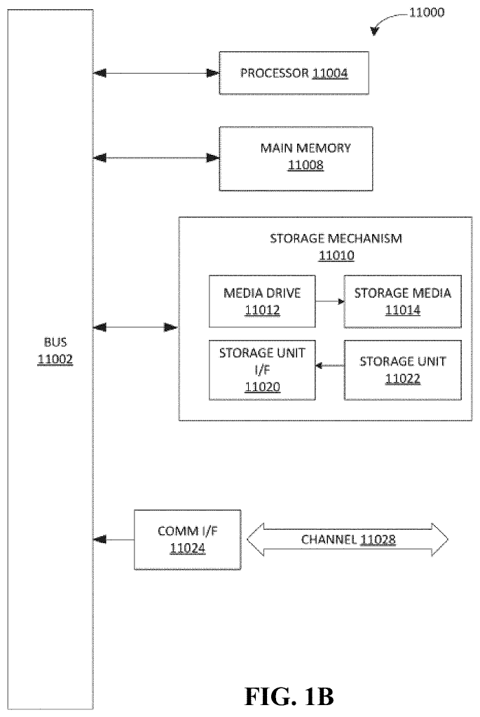

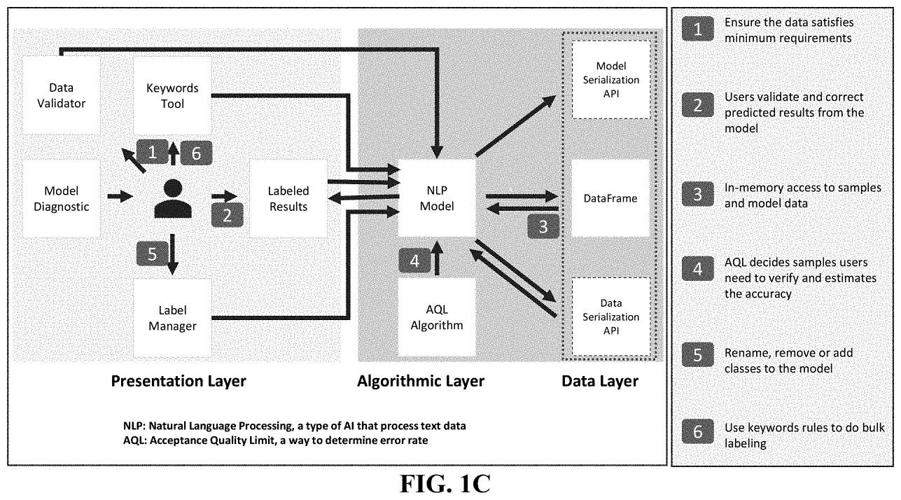

HARDWARD/SOFTWARE: FIG. 1A is a diagram illustrating one embodiment of a system for labeling an unlabeled dataset. In some implementations, system 100 may include one or more servers 102. Server(s) 102 may be configured to communicate with one or more client computing platforms 104 according to a client/server architecture and/or other architectures. Client computing platform(s) 104 may be configured to communicate with other client computing platforms via server(s) 102 and/or according to a peer-to-peer architecture and/or other architectures. Users may access system 100 via client computing platform(s) 104.

Server(s) 102 may include one or more processors 166 and one or more non-transitory memories with machine readable instructions (computer executable instructions) 106 embedded thereon. In some embodiments, a processor 166 and non-transitory memory with machine readable instructions 106 embedded thereon may form a logical circuit. In some examples, server(s) 102 may include one or more logical circuits. The logical circuits may include computer program modules.

In some examples, server(s) 102 may include one or more of a labeled dataset logical circuit 108, a classification model logical circuit 110, an unlabeled dataset logical circuit 112, a classification model application logical circuit 114, a verification quantity determination logical circuit 116, a verification dataset logical circuit 118, a classification model update logical circuit 120, an updated classification model application logical circuit 122, and/or other logical circuits and/or instruction modules.

Labeled dataset logical circuit 108 may be configured to obtain a labeled dataset to serve as training data (and may therefore be referred to as a training data obtaining logical circuit). The labeled dataset comprises a first plurality of data inputs and corresponding labels. In some embodiments, the labeled dataset may be manually reviewed and labeled by a user (e.g., human SME) and entered a database, spreadsheet, etc. for use to train a classification model to label an unlabeled dataset.

Classification model logical circuit 110 may be configured to train the classification model using the labeled dataset (and may therefore be referred to as a classification model generating logical circuit). The classification model may include a machine learning algorithm, e.g., a convolutional neural network, a long short-term memory network, a fully connected network, or any combination thereof, or other machine learning algorithm as known in the art.

Unlabeled dataset logical circuit 112 may be configured to obtain the unlabeled dataset to be labeled by the classification model. The unlabeled dataset comprises a second plurality of data inputs without corresponding labels. In some embodiments, the unlabeled dataset may be entered into a database, spreadsheet, etc.

Classification model application logical circuit 114 may be configured to apply the classification model to the unlabeled dataset. In some embodiments, the classification model is applied to the unlabeled dataset to generate a predicted label for each data input of the unlabeled dataset. Furthermore, the classification model application logical circuit 114 may be configured to generate a confidence level for each of the predicted labels.

Verification quantity determination logical circuit 116 may be configured to determine a verification quantity of the predicted labels to be verified by a user. In some embodiments, an Acceptance Quality Limit (AQL) algorithm may be used to determine the verification quantity of the predicted labels to be verified by the user. AQL is discussed herein.

Verification dataset logical circuit 118 may be configured to obtain a verification dataset for the determined verification quantity of the predicted labels verified by the user. The verification dataset comprises an update to at least one predicted label generated by the classification model.

Classification model update logical circuit 120 may be configured to update the classification model using the verification dataset.

Updated classification model application logical circuit 122 may be configured to apply the updated classification model to the remaining predicted labels that did not undergo verification and update the remaining predicted labels in response to the updated classification model.

Updated classification model application logical circuit 122 may also be configured to handle accuracy related functions. As an example, the updated classification model application logical circuit 122 may be configured to determine an accuracy estimate of the updated classification model. Furthermore, the updated classification model application logical circuit 122 may be configured to compare the accuracy estimate for the updated classification model with an accuracy threshold.

As discussed hereinbelow, one or more steps may be iterated. Some embodiments include iterating at least one of (e), (f), (g), (h), or any combination thereof in response to a comparison of the accuracy estimate of the updated classification model and the accuracy threshold. Some embodiments include iterating at least one of (e), (f), (g), (h), or any combination thereof in response to obtaining user input that initiates an iteration. Some embodiments include iterating at least one of (e), (f), (g), (h), or any combination thereof in response to obtaining a keyword for bulk labeling. Thus, one or more of the logical circuits 116, 118, 120, and/or 122 may be invoked during the iteration.

Representation component 124 may be configured to display one or more representations. For example, the representation component 124 may be configured to display a visual representation of the determined verification quantity of the predicted labels and corresponding data input of the unlabeled dataset via a graphical user interface. For example, the representation component 124 may be configured to display a visual representation of at least a portion of the generated confidence levels via a graphical user interface. For example, the representation component 124 may be configured to display a visual representation of the accuracy estimate of the updated classification model via a graphical user interface. The representations may be generated using a processor and the output may be stored in a data storage device and/or displayed in a graphical user interface. The representations may use visual effects to display at least some of the corresponding information. In some implementations, a visual effect may include a visual transformation of the representation. A visual transformation may include a visual change in how the representation is presented or displayed. In some implementations, a visual transformation may include a visual zoom, a visual filter, a visual rotation, and/or a visual overlay (e.g., text and/or graphics overlay).

In some implementations, server(s) 102, client computing platform(s) 104, and/or external resources 162 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which server(s) 102, client computing platform(s) 104, and/or external resources 162 may be operatively linked via some other communication media.

A given client computing platform 104 may include one or more processors configured to execute computer program modules. The computer program modules may be configured to enable an expert or user associated with the given client computing platform 104 to interface with system 100 and/or external resources 162, and/or provide other functionality attributed herein to client computing platform(s) 104. By way of non-limiting example, the given client computing platform 104 may include one or more of a desktop computer, a laptop computer, a handheld computer, a tablet computing platform, a NetBook, a Smartphone, a gaming console, and/or other computing platforms.

External resources 162 may include sources of information outside of system 100, external entities participating with system 100, and/or other resources. In some implementations, some or all of the functionality attributed herein to external resources 162 may be provided by resources included in system 100.

Server(s) 102 may include electronic storage 164, one or more processors 166, and/or other components. Server(s) 102 may include communication lines, or ports to enable the exchange of information with a network and/or other computing platforms. Illustration of server(s) 102 in FIG. 1A is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 164 may comprise non-transitory storage media that electronically stores information. The electronic storage media of electronic storage 164 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 164 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 164 may include one or more virtual storage resources (e.g., cloud storage, a virtual private network, and/or other virtual storage resources). Electronic storage 164 may store software algorithms, information determined by processor(s) 166, information received from server(s) 102, information received from client computing platform(s) 104, and/or other information that enables server(s) 102 to function as described herein.

Processor(s) 166 may be configured to provide information processing capabilities in server(s) 102. As such, processor(s) 166 may include one or more of a digital processor, an analog processor, a digital circuit designed to process information, an analog circuit designed to process information, a state machine, and/or other mechanisms for electronically processing information. Although processor(s) 166 is shown in FIG. 1A as a single entity, this is for illustrative purposes only. In some implementations, processor(s) 166 may include a plurality of processing units. These processing units may be physically located within the same device, or processor(s) 166 may represent processing functionality of a plurality of devices operating in coordination. Processor(s) 166 may be configured to execute machine-readable instructions as indicated by logical circuits 108, 110, 112, 118, 120, 124, and/or other modules. Processor(s) 166 may be configured to execute modules corresponding to logical circuits 108, 110, 112, 118, 120, 124, and/or other modules by software; hardware; firmware; some combination of software, hardware, and/or firmware; and/or other mechanisms for configuring processing capabilities on processor(s) 166. As used herein, the term “module” may refer to any component, logical circuit or set of components or logical circuits that perform the functionality attributed to the module. This may include one or more physical processors during execution of processor readable instructions, the processor readable instructions, circuitry, hardware, storage media, or any other components.

It should be appreciated that although logical circuits 108, 110, 112, 118, 120, and 124 are illustrated in FIG. 1A as being implemented within a single processing unit, in implementations in which processor(s) 166 includes multiple processing units, one or more of logical circuits 108, 110, 112, 118, 120, and/or 124 may be implemented remotely from the other modules. The description of the functionality provided by the different logical circuits 108, 110, 112, 118, 120, and/or 124 described below is for illustrative purposes, and is not intended to be limiting, as any of logical circuits 108, 110, 112, 118, 120, and/or 124 may provide more or less functionality than is described. For example, one or more of logical circuits 108, 110, 112, 118, 120, and/or 124 may be eliminated, and some or all of its functionality may be provided by other ones of logical circuits 108, 110, 112, 118, 120, and/or 124. As another example, processor(s) 166 may be configured to execute one or more additional modules that may perform some or all of the functionality attributed below to one of logical circuits 108, 110, 112, 118, 120, and/or 124.

As will be appreciated, the method as described herein may be performed using a computing system having machine executable instructions stored on a tangible medium. The instructions are executable to perform each portion of the method, either autonomously, or with the assistance of input from an operator.

The term component may also be utilized instead of logical circuit. For example, either a logical circuit or a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. In implementation, the various components described herein might be implemented as discrete components or the functions and features described can be shared in part or in total among one or more components. In other words, as would be apparent to one of ordinary skill in the art after reading this description, the various features and functionality described herein may be implemented in any given application and can be implemented in one or more separate or shared components in various combinations and permutations. Even though various features or elements of functionality may be individually described or claimed as separate components, one of ordinary skill in the art will understand that these features and functionality can be shared among one or more common software and hardware elements, and such description shall not require or imply that separate hardware or software components are used to implement such features or functionality.

Where components, logical circuits, or components of the technology are implemented in whole or in part using software, in one embodiment, these software elements can be implemented to operate with a computing or logical circuit capable of carrying out the functionality described with respect thereto. One such example logical circuit is shown in FIG. 1B. Various embodiments are described in terms of this example logical circuit 11000. After reading this description, it will become apparent to a person skilled in the relevant art how to implement the technology using other logical circuits or architectures.

Referring now to FIG. 1B, computing system 11000 may represent, for example, computing or processing capabilities found within desktop, laptop and notebook computers; hand-held computing devices (PDA's, smart phones, cell phones, palmtops, etc.); mainframes, supercomputers, workstations or servers; or any other type of special-purpose or general-purpose computing devices as may be desirable or appropriate for a given application or environment. Logical circuit 11000 might represent computing capabilities embedded within or otherwise available to a given device. For example, a logical circuit might be found in other electronic devices such as, for example, digital cameras, navigation systems, cellular telephones, portable computing devices, modems, routers, WAPs, terminals and other electronic devices that might include some form of processing capability.

Computing system 11000 might include, for example, one or more processors, controllers, control components, or other processing devices, such as a processor 11004. Processor 11004 might be implemented using a general-purpose or special-purpose processing component such as, for example, a microprocessor, controller, or other control logic. In the illustrated example, processor 11004 is connected to a bus 11002, although any communication medium can be used to facilitate interaction with other components of logical circuit 11000 or to communicate externally.

Computing system 11000 might include one or more memory components, simply referred to herein as main memory 11008. For example, preferably random access memory (RAM) or other dynamic memory, might be used for storing information and instructions to be executed by processor 11004. Main memory 11008 might be used for storing temporary variables or other intermediate information during execution of instructions to be executed by processor 11004. Logical circuit 11000 might likewise include a read only memory (“ROM”) or other static storage device coupled to bus 11002 for storing static information and instructions for processor 11004.

The computing system 11000 might include one or more various forms of information storage mechanism 11010, which might include, for example, a media drive 11012 and a storage unit interface 11020. The media drive 11012 might include a drive or other mechanism to support fixed or removable storage media 11014. For example, a hard disk drive, a floppy disk drive, a magnetic tape drive, an optical disk drive, a CD or DVD drive (R or RW), or other removable or fixed media drive might be provided. Accordingly, storage media 11014 might include, for example, a hard disk, a floppy disk, magnetic tape, cartridge, optical disk, a CD or DVD, or other fixed or removable medium that is read by, written to or accessed by media drive 11012. As these examples illustrate, the storage media 11014 can include a computer usable storage medium having stored therein computer software or data.

In alternative embodiments, information storage mechanism 11010 might include other similar instrumentalities for allowing computer programs or other instructions or data to be loaded into logical circuit 11000. Such instrumentalities might include, for example, a fixed or removable storage unit 11022 and an interface 11020. Examples of such storage units 11022 and interfaces 11020 can include a program cartridge and cartridge interface, a removable memory (for example, a flash memory or other removable memory component) and memory slot, a PCMCIA slot and card, and other fixed or removable storage units 11022 and interfaces 11020 that allow software and data to be transferred from the storage unit 11022 to logical circuit 11000.

Logical circuit 11000 might include a communications interface 11024. Communications interface 11024 might be used to allow software and data to be transferred between logical circuit 11000 and external devices. Examples of communications interface 11024 might include a modem or soft modem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 11024 might typically be carried on signals, which can be electronic, electromagnetic (which includes optical) or other signals capable of being exchanged by a given communications interface 11024. These signals might be provided to communications interface 11024 via a channel 11028. This channel 11028 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer readable medium” or “computer program medium” or “computer usable medium” or the like are used to generally refer to media such as, for example, memory 11008, storage unit 11020, media 11014, and channel 11028. These and other various forms of computer program media or computer usable media may be involved in carrying one or more sequences of one or more instructions to a processing device for execution. Such instructions embodied on the medium, are generally referred to as “computer executable instructions” or “computer program code” or a “computer program product” (which may be grouped in the form of computer programs or other groupings) or “computer executable instructions” or the like. When executed, such instructions might enable the logical circuit 11000 to perform features or functions of the disclosed technology as discussed herein.

Although at least one figure depicts a computer network, it is understood that the disclosure is not limited to operation with a computer network, but rather, the disclosure may be practiced in any suitable electronic device. Accordingly, the computer network depicted in figure is for illustrative purposes only and thus is not meant to limit the disclosure in any respect.

FIG. 1C illustrates a diagram of one embodiment of a system architecture consistent with the instant disclosure, including a data layer, an algorithmic layer, and a presentation layer. Again, FIG. 1C is a non-limiting embodiment.

EMBODIMENTS: FIG. 2A illustrates an embodiment of a method of labeling an unlabeled dataset, referred to as a method 205. FIG. 2A provides a simplified version for easy of understanding and more details are provided in FIGS. 2B-2C. The method 205 may be executed by a computing system or architecture in one or more of the figures, such as FIGS. 1A-1C. The AQL score at 210 is more like a threshold of samples that a SME can correct. If this threshold is exceeded, it means the accuracy is lower. Below is an example to help illustrate the case. Suppose there are 1000 samples to label, then Table 1's “501-1200” row may be checked, “G” from “General Inspection Levels” may be chosen (J or K could be chosen, just different levels of stringency), and from Table 2, “G” translates to “Get 32 samples”. If expected error rate is 1.5%, then a SME does not correct more than 2 samples out of the 32 samples. If otherwise the SME corrected 15 samples, the estimated error rate is 25%. And if tolerance for the error rate is 1.5%, then the “AQL score” has not been passed, and another iteration may be pursued. Table 1, Table 2, and AQL are discussed further in connection with FIGS. 2B-2C.

FIGS. 2B-2C illustrate another embodiment of a method of labeling an unlabeled dataset, referred to as a method 249. The method 249 may be executed by a computing system or architecture in one or more of the figures, such as FIGS. 1A-1C.

At 250, the method 249 includes (a) obtaining a labeled dataset comprising a first plurality of data inputs and corresponding labels. The term “obtaining” may include receiving, retrieving, accessing, generating, etc. or any other manner of obtaining data. The labeled dataset will be used for training a classification model and includes a plurality of data inputs and a plurality of labels, such that each data input (sometimes referred to as a data sample, sample, or input data) has a corresponding label (sometimes referred to as a class or a tag). A user may use a graphical user interface (GUI) to select the label for each data input from a plurality of labels (e.g., select from at least two labels or select from at least two classes). The user may be a human user, such as a subject matter expert (SME) in the domain. As an example, the user may select label_1 for datum_A, label_1 for datum_B, label_6 for datum_C, etc. Each label assigned by a user may be considered to have a confidence level of 100%.

The size of the labeled dataset may vary, but in general, accuracy may be improved with a larger labeled dataset. In one embodiment, the labeled dataset may include 100 to 1,900 data inputs or 1,000 to 1,900 data inputs data inputs, with each data input having a corresponding label. In one embodiment, the labeled dataset may be 1%-20% of the unlabeled dataset or 10%-20% of the unlabeled dataset of the unlabeled dataset, with each data input having a corresponding label. Even if the size of the labeled dataset is on the smaller side, the verification quantity and/or the iterative updating of the classification model may be utilized to improve the classification model and the output to make up for a smaller labeled dataset.

A “data input” may be a data record (or a portion of a data record) such as a data record for an event, a file name (or a portion of a file name), a video, an image (or a portion of an image) such as a seismic image, a downhole image (or portion of a downhole image), a photo, an audio file (or a portion of an audio file), etc. The “data input” may include a letter, a number, a symbol that is not a letter or a number, an image, a portion of an image, or any combination thereof. The symbol in the data input may include punctuation (e.g., period, colon, etc.), underscore, ampersand, number or hash, percentage, slash, bracket, parenthesis, hyphen, etc. In some embodiments, each data input may be related to the hydrocarbon industry.

A “label” of a data input may include a letter, a number, a symbol that is not a letter or a number, an image, or any combination thereof. The symbol in the label may include punctuation (e.g., period, colon, etc.), underscore, ampersand, number or hash, percentage, slash, bracket, parenthesis, hyphen, etc. The label may be in the form of text in some embodiments. The label may be in the form of an image in some embodiments, for example, the user may draw an image label around a fracture network or other structure on a seismic image via a graphical user interface (GUI). The user may even draw a plurality of image labels on a single image, such as a seismic image, in some embodiments (e.g., the user draws two image labels on a single seismic image representing two fracture networks, the user draws an image label for a fracture network and draws an image label for some other structure on a single seismic image, etc.). Alternatively, the label may be in the form of an image, as well as including a letter, a number, a symbol, or any combination thereof in the label in some embodiments. In some embodiments, each label may be related to the hydrocarbon industry.

As an example, the labeled dataset may include a data record containing letters, numbers, and symbols (i.e., data input) with a label in the form of the text “Weather” or “Maintenance” (i.e., text label). As an example, the labeled dataset may include a file name (first column in TABLE A) and/or data input (second column in TABLE A) such as metadata that contains letters, numbers, and symbols (i.e., data input) with a label in the form of the text “Delete”, “Keep”, or “POSTPONE” (i.e., text label) as in TABLE A below. The labeled dataset in TABLE A may be utilized to predict labels for unlabeled files, for example, when determining which files to keep or delete in a repository, such as a work-related repository. The label of “POSTPONE” may even be predicted for personal data items stored in the work-related repository. The file name (first column in TABLE A), the data input (second column in TABLE A), or a combination of the file name and the data input may be utilized for labeling.

TABLE A

| File | Input | Labels |
|---|---|---|
| ./Location0/12_cmr.dis | back to years ago | Delete |
| ./Location0/Location0_kk1_1.cks | Lab report aa1 | Keep |
| ./keny/12_cats.jpg | cat pictures | POST- |
| | from Christmas | PONE |
| ./Location0/Location0_kk1_3.ck | Geological report 1 | Keep |
| ./Location0/Location0_kk1_4.cv | Geological report 12a | Keep |
| ./Location0/Location0_kk1_5.labk | Geological report 14b | Keep |

As an example, the labeled dataset may include an image or a portion of an image (i.e., data input) with a label in the form of the text “fracture network” (i.e., text label) and/or with a label in the form of an image indicating a fracture network (i.e., image label). As an example, the labeled dataset may include an image or a portion of an image (i.e., data input) with a label in the form of the text “channel” (i.e., text label) and/or with a label in the form of an image indicating a channel (i.e., image label). As an example, the labeled dataset may include an image or a portion of an image (i.e., data input) with a label in the form of the text “geobody” (i.e., text label) and/or with a label in the form of an image indicating a geobody (i.e., image label).

Those of ordinary skill in the art will appreciate that the terms “data input” and “label” are not limited to any of the embodiments provided herein.

At 255, the method 249 includes (b) training a classification model using the labeled dataset. The labeled dataset has labels assigned by the user, such as the SME, as described at 250. In one embodiment, the classification model comprises a machine learning algorithm. The machine learning algorithm comprises a convolutional neural network (CNN), a long short-term memory (LSTM) network, a fully connected network (e.g., a neural network having 1-2 layers that is not a CNN), or any combination thereof. In one embodiment, a convolutional neural network only is utilized. In one embodiment, the convolutional neural network is utilized before the long short-term memory network. If the data inputs of the first plurality are images without text, for example, then CNN only may be utilized in one embodiment. This is not an exhaustive list, and for example, other neural networks may be utilized in some embodiments. In one embodiment, the classification model is trained with conventional techniques using a convolutional neural network (CNN), a long short-term memory (LSTM) network, a fully connected network (e.g., a neural network having 1-2 layers that is not a CNN), or any combination thereof.

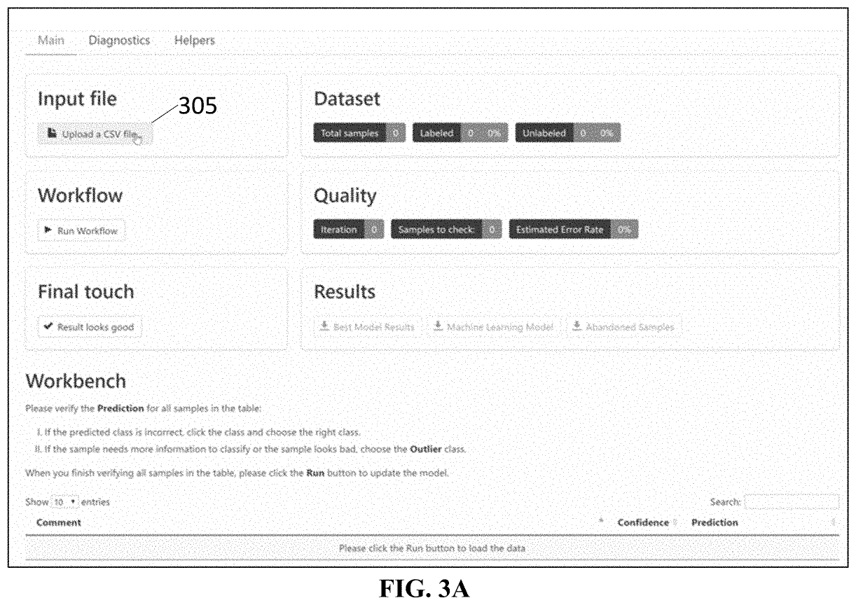

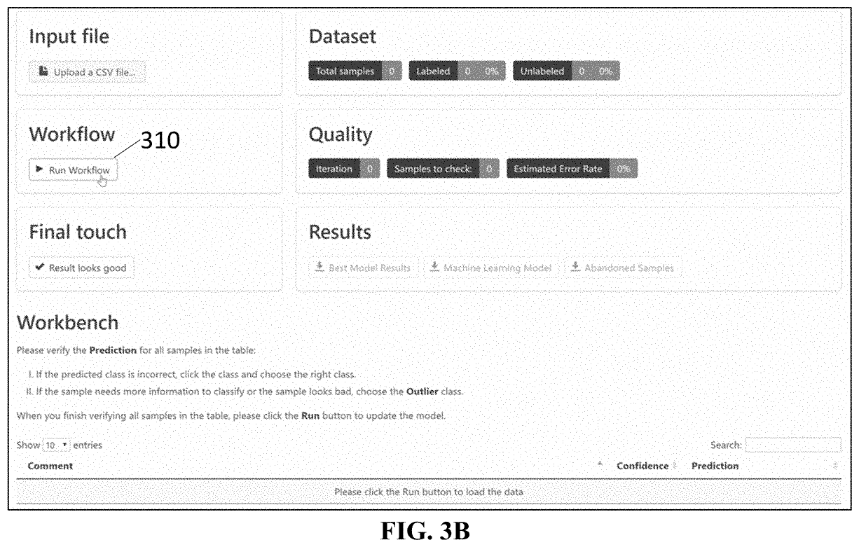

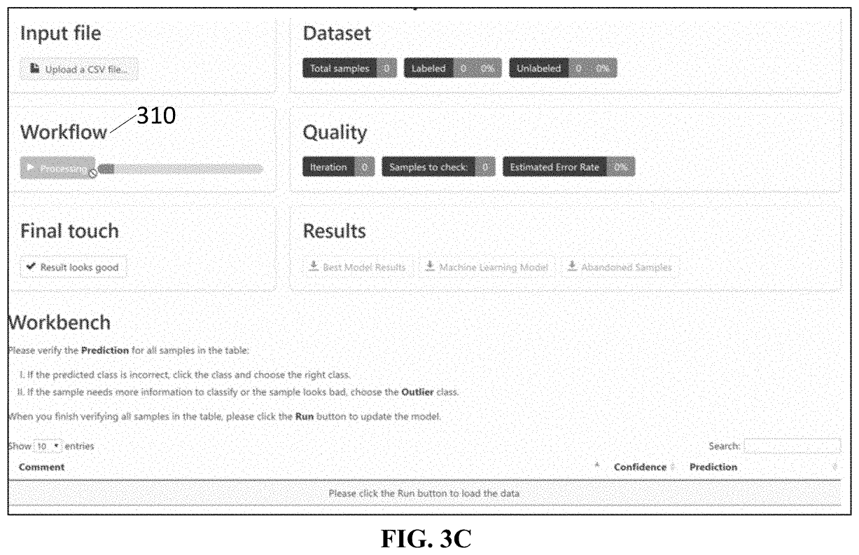

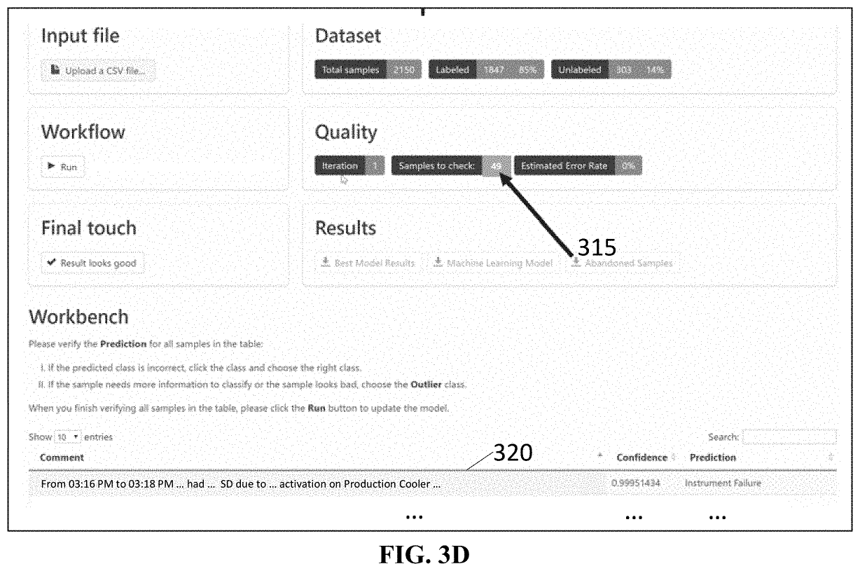

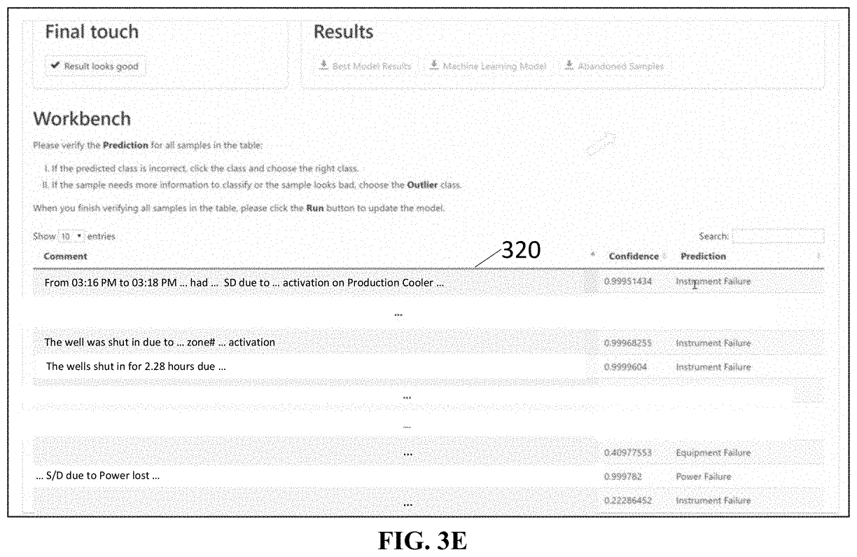

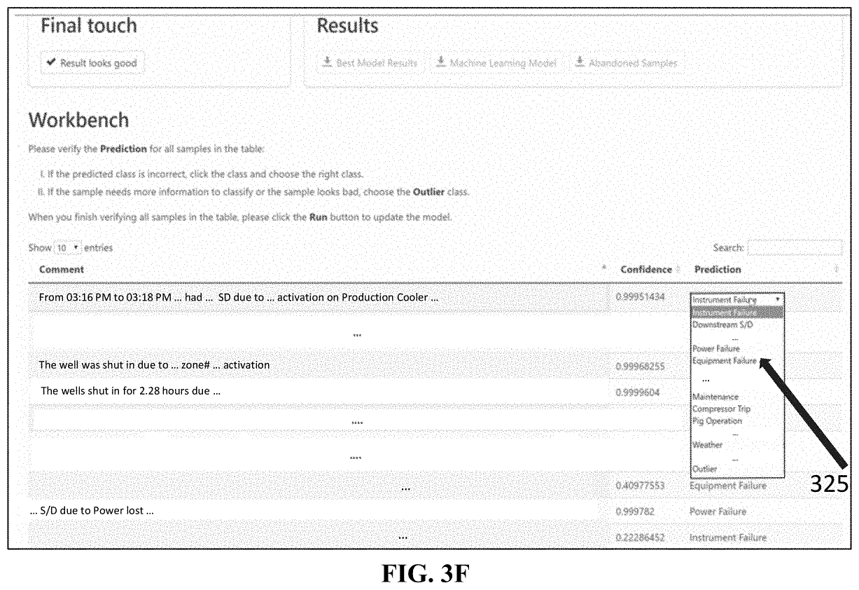

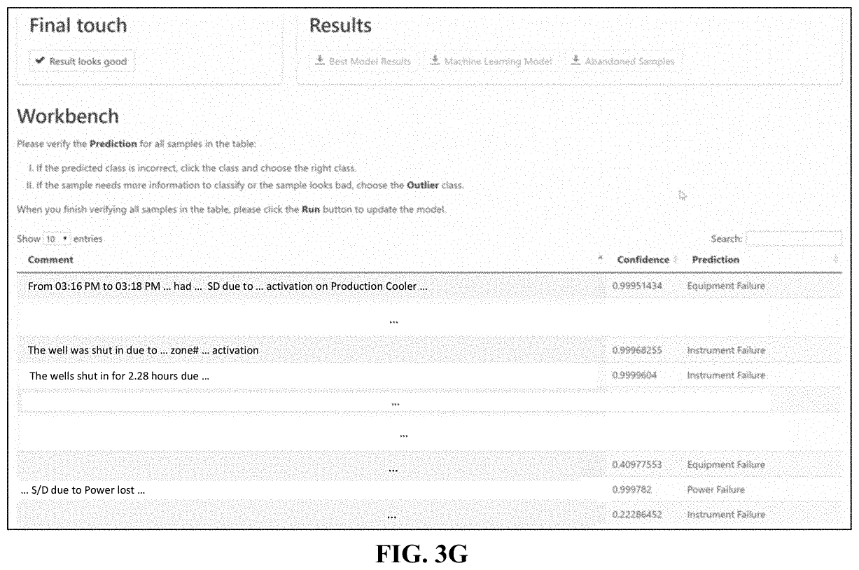

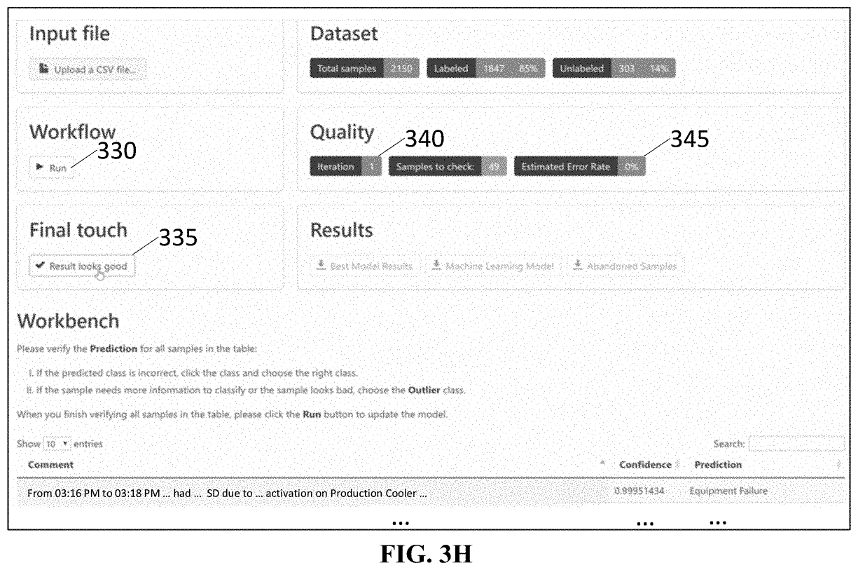

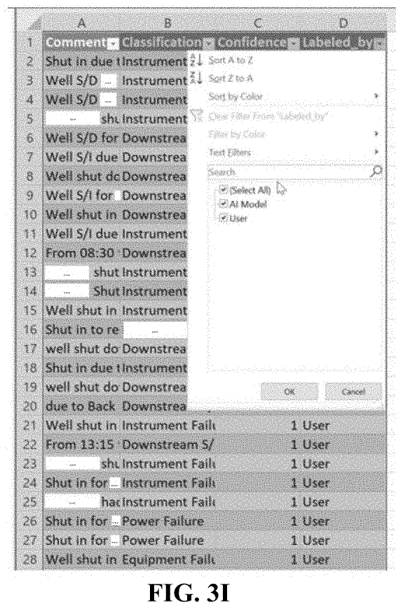

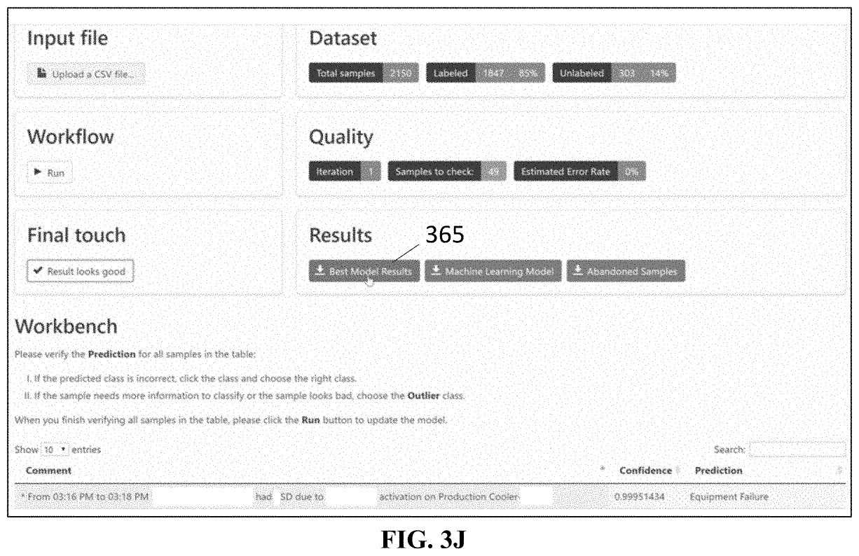

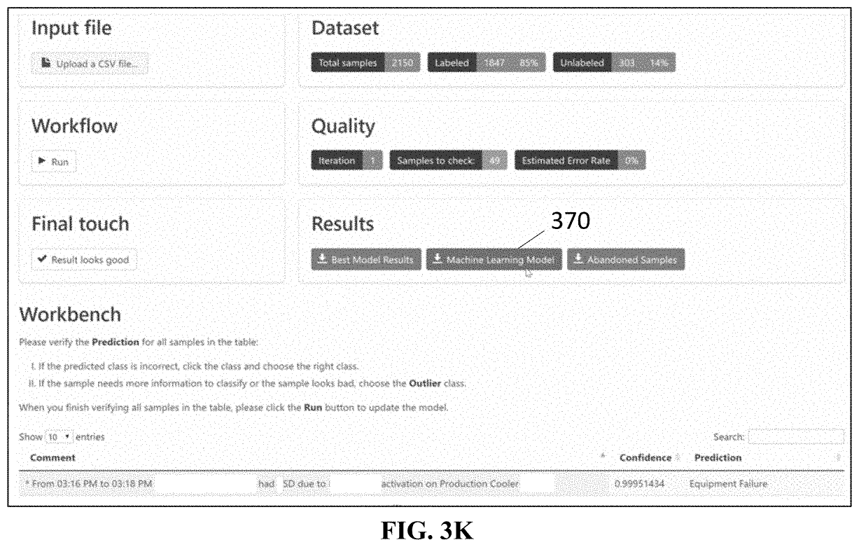

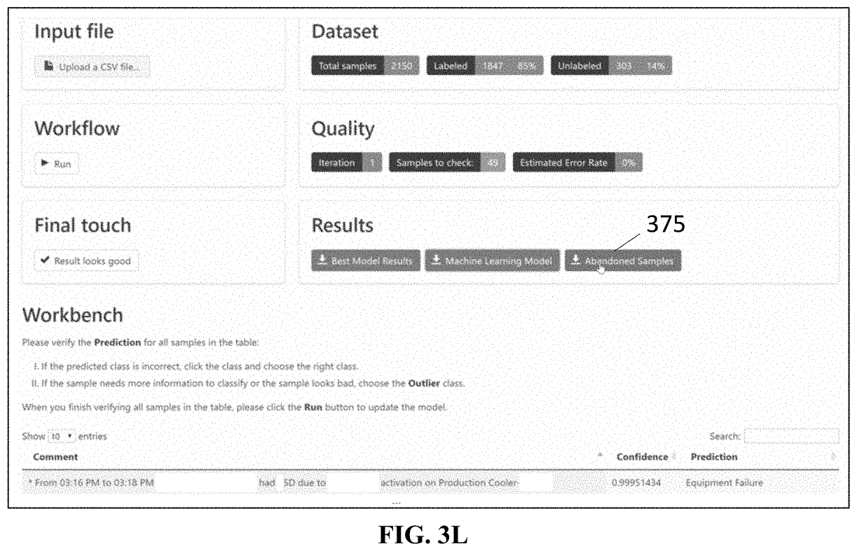

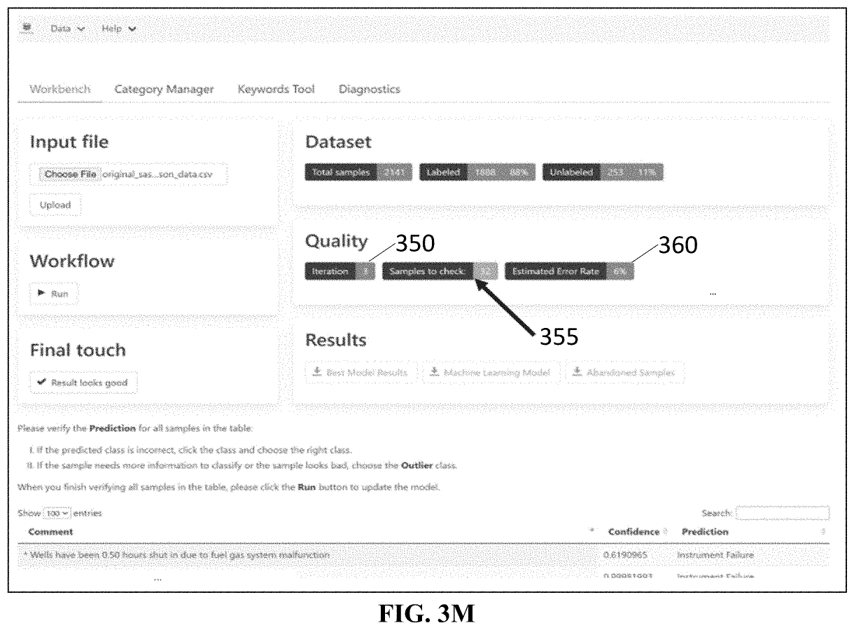

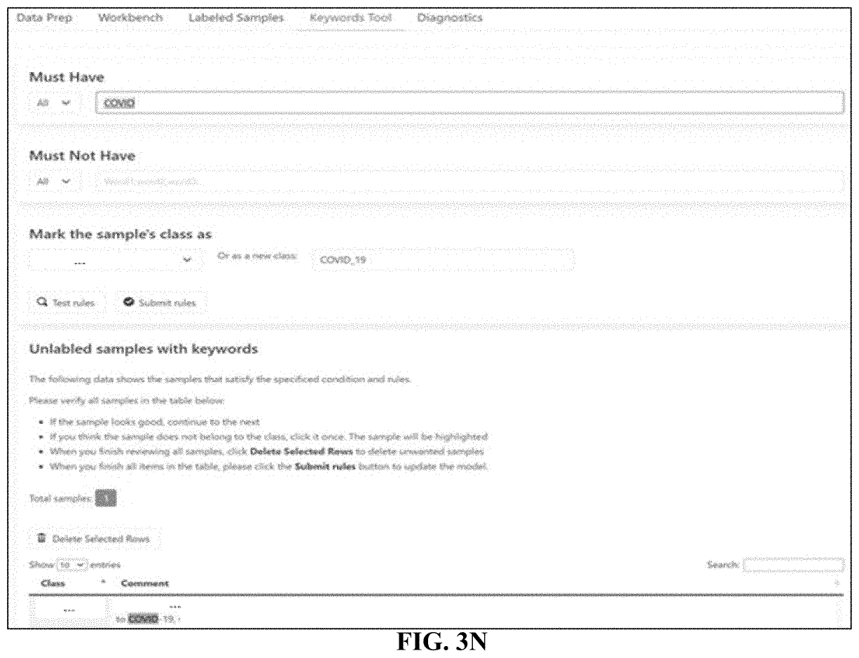

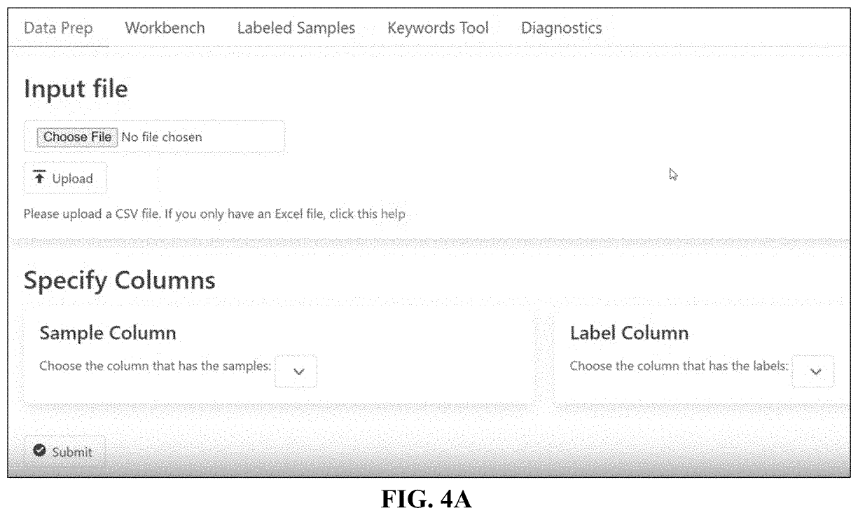

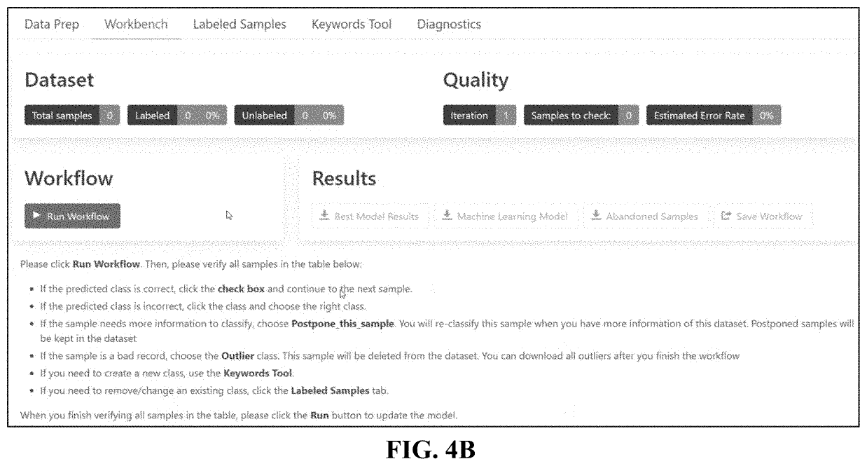

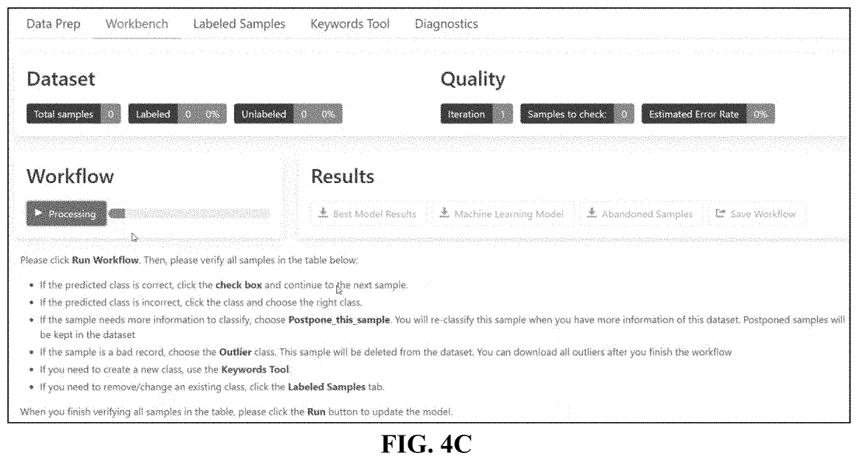

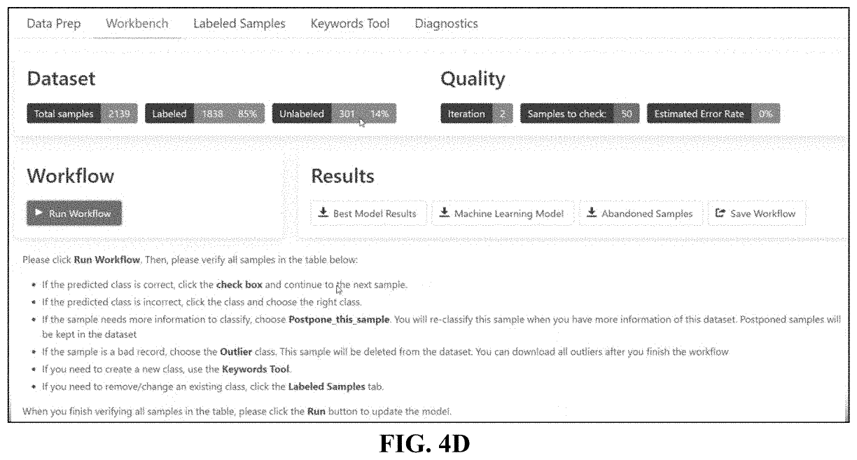

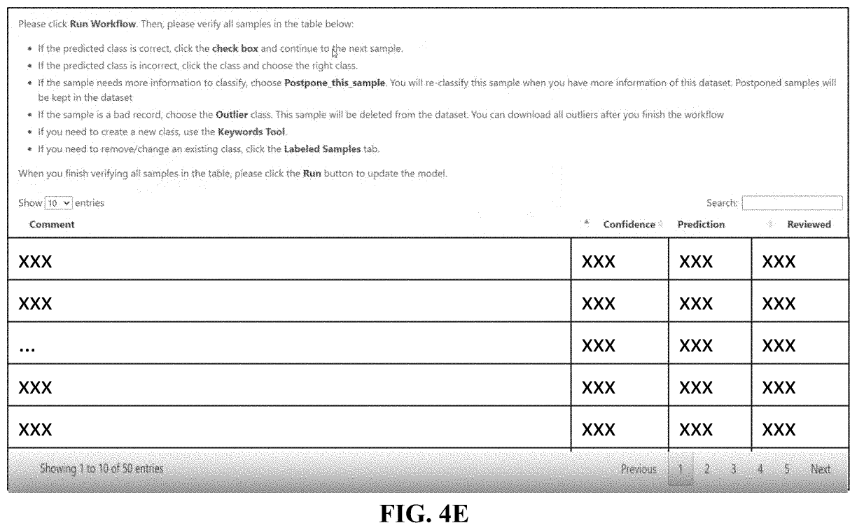

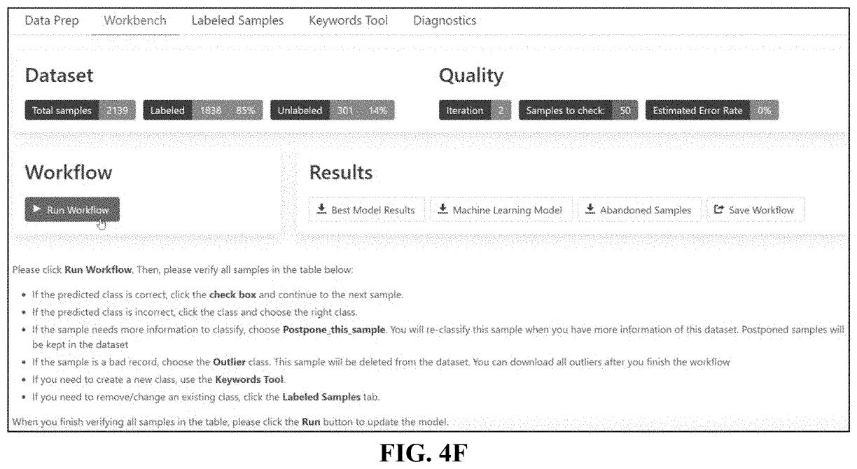

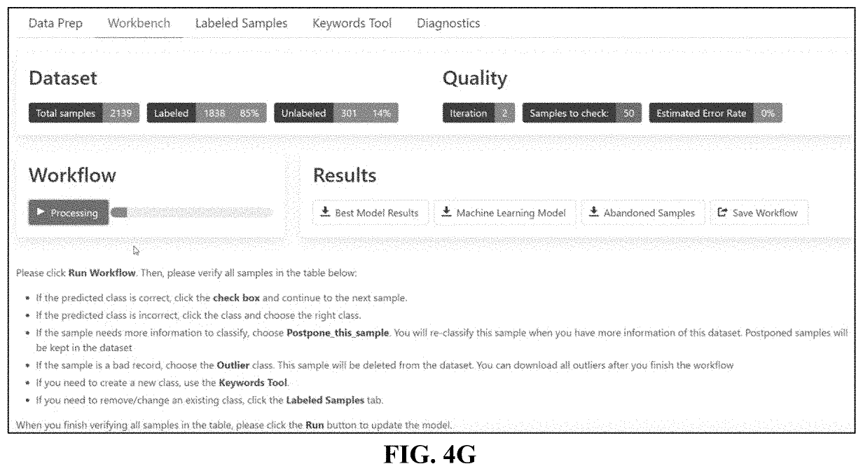

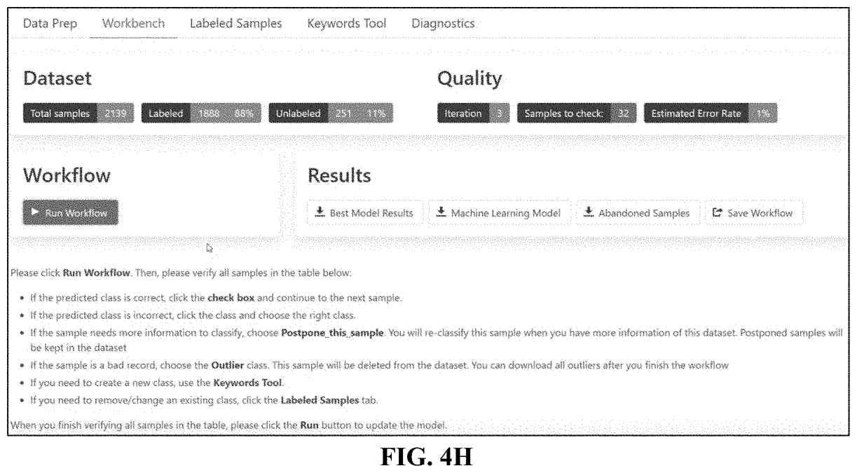

At 260, the method 249 includes (c) obtaining the unlabeled dataset comprising a second plurality of data inputs without corresponding labels. For example, the user (e.g., SME) has not assigned labels to the data inputs in the unlabeled dataset, and the machine learning based classification model will predict labels for the unlabeled dataset. As described in the examples in FIGS. 3A-3N and 4AJ, a single file (e.g., CSV or spreadsheet) may even be uploaded that contains both the labeled dataset and the unlabeled dataset in some embodiments. The unlabeled dataset may include data inputs without labels in the same domain as the data inputs of the labeled dataset. The domain may be maintenance data, safety data, seismic data, etc.

At 265, the method 249 includes (d) applying the classification model to the unlabeled dataset to generate a predicted label for each data input of the unlabeled dataset. In one embodiment, the classification model generates predicted labels with conventional techniques specific to that type of classification model. For example, a CNN based classification model may use conventional techniques applicable to CNN based classification models for generating predicted labels. The classification model will generate predicted labels for the unlabeled dataset from the classes or labels that the user (e.g., SME) could select from when the user labeled the labeled dataset.

At 270, the method 249 includes (e) determining a verification quantity of the predicted labels to be verified by a user. In one embodiment, an Acceptance Quality Limit (AQL) algorithm is used to determine the verification quantity of the predicted labels to be verified by the user. Acceptance Quality Limit or AQL is defined as the “quality level that is the worst tolerable” in ISO 2859-1 (i.e., ISO 2859-1:1999 Sampling procedures for inspection by attributes—Part 1: Sampling schemes indexed by acceptance quality limit (AQL) for lot-by-lot inspection, which is incorporated by reference). It represents the maximum number of defective units, beyond which a batch is rejected, and more information is available at ISO 2859-1:1999 at https://www.iso.org/standard/1141.html and at https://qualityinspection.org/what-is-the-aql/dated Aug. 18, 2018 with the title: What is the “AQL” (Acceptance Quality Limit) in simple terms?, each of which is incorporated by reference. For example, Table 2 with the title Sampling & Acceptance Limits at https://qualityinspection.org/what-is-the-aql/, which is incorporate by reference, is utilized to determine the verification quantity and for estimating accuracy of the updated classification model. As an example: Suppose that there are 1000 samples to label, then Table 1's “501-1200” row may be utilized, then “G” from “General Inspection Levels” may be chosen, and from Table 2, “G” translates to “Get 32 samples”. If expected accuracy is 1.5%, then the SME does not correct more than 2 samples out of the 32 samples. Table 1 with the title Sample Size Code Letters is found at the same links above.

A common question in conventional approaches is how many samples to label. Embodiments consistent with the instant disclosure may use the AQL algorithm to alleviate this quandary because (a) the samples to check by the user may depend on both the total samples and the target accuracy, (b) compared to other selection approaches, the AQL algorithm is data driven in accordance with designed statistical criteria (i.e., not ad-hoc), and/or (c) the AQL algorithm may achieve better performance in the context of the problem of study, short text classification, etc.

Optionally, the method 249 includes, at 271, displaying a visual representation of the determined verification quantity of the predicted labels and corresponding data inputs with predicted labels of the unlabeled dataset via a graphical user interface for verification. For example, assuming that the determined verification quantity is 49 at 249, then a visual representation of 49 predicated labels and the corresponding 49 data inputs from the unlabeled dataset be displayed via a GUI for verification by a user (e.g., SME). The examples section hereinbelow provides various examples of this visual representation.

Optionally, the method 249 includes, at 286, generating a confidence level for the predicted labels; displaying a visual representation of at least a portion of the generated confidence levels via a graphical user interface; or any combination thereof. For example, a confidence level may be generated by the classification model for a predicted label when the predicted label is generated by the classification model at 265. A visual representation of the confidence level may be displayed via a GUI to a user at 271 to help the user review the determined verification quantity of predicted labels. For example, assuming that the determined verification quantity is 49 at 249, then a visual representation of 49 predicated labels, 49 confidence levels for the 49 predicted labels, and the corresponding 49 data inputs from the unlabeled dataset be displayed via a GUI for verification by a user (e.g., SME). The examples section hereinbelow provides various examples of this visual representation.

At 275, the method 249 includes (f) obtaining a verification dataset for the determined quantity of the predicted labels verified by the user. The verification dataset comprises an update to at least one predicted label generated by the classification model. For example, assuming that the determined verification quantity is 49 at 249, after a visual representation of 49 predicated labels and the corresponding 49 data inputs from the unlabeled dataset be displayed via a GUI for verification by a user (e.g., SME) as in 271 and/or with confidence levels as in 286, the user may change at least one predicated label generated by the classification model to another label using that GUI and submit the change(s) as the verification dataset. The user may even change all 49 predicted labels if the user is not satisfied with the 49 predicated labels generated by the classification model. In one embodiment, the verification dataset can include predicted labels that the user that did not update as well as the predicted labels that the user did update. In one embodiment, the verification dataset can include only the predicted labels that the user did update.

At 280, the method 249 includes (g) updating the classification model using the verification dataset. The verification dataset will be used to update (e.g., re-train) the classification model to improve the accuracy of future predicted labels generated by the classification model. For example, if a CNN based classification model was trained at 255, then conventional techniques applicable to updating CNN based classification models may be used.

At 285, the method 249 includes (h) applying the updated classification model to the remaining predicted labels that did not undergo verification and updating the remaining predicted labels in response to the updated classification model. As explained at 264, in one embodiment, the updated classification model generates predicted labels with conventional techniques specific to that type of classification model. For example, an updated CNN based classification model may use conventional techniques applicable to CNN based classification models for generating predicted labels. The updated classification model will generate predicted labels for the remaining unlabeled dataset that did not undergo verification from the classes or labels that the user (e.g., SME) could select from when the user labeled the labeled dataset. Regarding updating the remaining predicted labels in response to the updated classification model, one or more predicted labels (and corresponding confidence levels, if any, as discussed at 286) may be updated by the updated classification model based on the updates (e.g., re-training) to the classification model. The updated classification model may leave one or more predicted labels as is based on the updates (e.g., re-training) to the classification model. The verification dataset has already been verified by a user and therefore it may be more efficient to focus on updating the remaining predicted labels that did not undergo verification and updated the remaining predicted labels in response to the updated classification model.

Optionally, the method 249 includes, at 287, determining an accuracy estimate of the updated classification model; displaying a visual representation of the accuracy estimate of the updated classification model via a graphical user interface; or any combination thereof. The visual representation of the accuracy estimate of the updated classification model may assist the user in determining whether another iteration should be pursued to further update the updated classification model or if the updated classification model is satisfactory. For example, Table 2 with the title Sampling & Acceptance Limits at https://qualityinspection.org/what-is-the-aql/, which is incorporate by reference, is utilized to determine the verification quantity and for estimating accuracy of the updated classification model. Table 2 is discussed further hereinabove at 270. The accuracy estimate of the updated classification model may be represented in terms of a percentage (e.g., 90%) or words (e.g., “high” terminology that corresponds to a range of predetermined values such as 90% or greater or 90%-99.99%, “medium” terminology that corresponds to a range of predetermined values such as at least 70% and less than 90%, “low” terminology that corresponds to a range of predetermined values such as less than 70%, etc.). The accuracy estimate of the updated classification model may also be determined based on the estimated error rate such that if the estimated error rate is 5% then the accuracy estimate is 95%. In some embodiments, the estimated error rate may even be utilized as the accuracy estimate of the updated classification. Indeed, the accuracy estimate of the updated classification model may be practically any indication of accuracy of the updated classification model. Practically any indication of the accuracy. The examples section hereinbelow provides various examples of this visual representation.

In some embodiments, the SME may be satisfied with a classification model that updated once using the verification quantity, especially if the accuracy estimate, if any, is high, and the SME may decide to proceed to the final labeled output.

On the other hand, the SME may not be satisfied with the updated classification model yet, especially if the accuracy estimate, if any, is low. Additionally, or alternatively, a common question in conventional techniques is what if the dataset quality is low. To alleviate these items, embodiments consistent with the instant disclosure may implemented in an SME assisted iterative manner to improve the final labeled output. For example, the SME assigns labels to a few samples/data inputs to train the classification model and afterwards the following steps may generally be repeated until a stopping conditions is reached: the classification model automatically predicts labels→SME verifies predicted labels for the verification quantity→the classification model is updated. An accuracy threshold may be utilized to automatically determine if the stopping condition has been met and/or the SME may determine if the stopping condition has been met (e.g., by looking at the accuracy estimate corresponding to the current updated classification model). Iteration is discussed further at 288, 289, and 290.

Turning to 288, 289, and 290, one or more steps may be iterated in some embodiments to continue to improve the updated classification model using a SME-assisted iterative process. Optionally, the method 249 includes, at 288, comparing the accuracy estimate for the updated classification model with an accuracy threshold; and iterating at least one of (e), (f), (g), (h) or any combination thereof in response to a comparison of the accuracy estimate of the updated classification model and the accuracy threshold. The accuracy threshold may be utilized to automatically iterate at least one of (e), (f), (g), (h) or any combination thereof until the accuracy threshold has been met or satisfied by the accuracy estimate of the classification model at that point. The user may select the accuracy threshold via a GUI.

As an example, if the accuracy threshold is 90% or greater (or estimated error rate of 10% or less) and the accuracy estimate of the updated classification model at 287 is 88% (or estimated error rate of 12%), then control may pass to (e) at 270 to determine a new verification quantity, the user verifies another group of predicted labels corresponding to the new verification quantity and that new verification dataset is obtained at (f) at 275, the updated classification model from 287 is updated with the new verification dataset at (g) at 280, and the new updated classification model from 280 is applied at (h) at 285. An accuracy estimate may be generated for the new updated classification model at 287, and if the new accuracy estimate is 89% (or estimated error rate of 11%) and doesn't meet the accuracy threshold, then steps (e), (f), (g), and (h) may be repeated until the accuracy threshold is met or satisfied.

Optionally, the method 249 includes, at 289, iterating at least one of (e), (f), (g), (h), or any combination thereof in response to obtaining user input that initiates an iteration. For example, the SME may initiate an iteration based on the displayed accuracy estimate at 287 with or without usage of an accuracy threshold. Indeed, the SME may initiate an iteration without usage of an accuracy threshold in some embodiments. The SME may initiate an iteration for practically any reason. The SME may initiate an iteration even after an accuracy threshold has been met or satisfied to further improve accuracy.

Optionally, the method 249 includes, at 290, iterating at least one of (e), (f), (g), (h), or any combination thereof in response to obtaining a keyword for bulk labeling. Bulk labeling may be utilized for efficiency to speed up labeling. For example, FIG. 3N that the keyword “COVID” or other keywords may be utilized to for bulk labelling of data inputs mentioning “COVID”. For example, the SME may initiate an iteration using bulk labeling.

At 295, the method 249 includes after (h), storing and/or displaying a visual representation of each data input and corresponding label. In one embodiment, after the classification model has been updated at least one, each data input and corresponding label may be stored in a data store to preserve the improvements thus far for future. In one embodiment, after all the iterations, each data input and corresponding label may be stored in a data store to preserve the improvements thus far for future. A visual representation may also be displayed. For example, in FIGS. 3J, 3K, and 3L, clicking “Best Model Results” (item 365) generates an output of the complete dataset with all corresponding SME labels and all corresponding predicted labels (e.g., in a spreadsheet such as FIG. 3I). In FIGS. 3J, 3K, and 3L, clicking “Machine Learning Model” (item 370) outputs a binary file corresponding to the machine learning classification model. In FIGS. 3J, 3K, and 3L, clicking “Abandoned Samples” (item 375) outputs a list of the data input labeled as “outlier” (e.g., in a spreadsheet). The examples section hereinbelow provides various examples of this visual representation.

EXAMPLE 1: FIGS. 3A-3N illustrate one embodiment of a tool for labeling an unlabeled dataset. In FIG. 3A, clicking “Upload a CSV file” (item 305) allows a labeled dataset, which includes a plurality of data inputs labeled by the SME, and the unlabeled dataset to be added to the tool. In FIGS. 3B-3D, clicking “Run Workflow” (item 310) starts the workflow to train a classification model using the labeled dataset and determine a verification quantity. FIG. 3D illustrates that 2150 data inputs (illustrated as Total samples) were loaded, and 1847 of those data inputs were labeled by the SME (illustrated as Labeled) and 303 of those data inputs were unlabeled (illustrated as Unlabeled). CNN was utilized to generate this classification model using the 1847 labeled dataset. The classification model was used to generate the predicted labels (illustrated in the Prediction column). The verification quantity is 49 as illustrated by the arrow 315 and the tool will illustrate 49 unlabeled data inputs with their predicted labels and confidence levels for the SME to verify. The 49 data inputs are generally illustrated towards the bottom of FIG. 3D and FIG. 3E in section 320. The verification quantity of 49 was determined using AQL. FIGS. 3E-3G illustrate that the SME is verifying predicted labels for the 49 data inputs in section 320 and changed one of the predicted labels. Specifically, the SME changed the predicted label of “Instrument Failure” in the first row to “Equipment Failure” (arrow 325) using the drop-down menu in FIG. 3F. The corrected label in the first row is illustrated in FIG. 3G.

In FIG. 3H, the SME may click “Run” (item 330) after verifying the 49 data inputs to start another iteration such as iteration two. The verification quantity will reduce during each iteration, and likewise, the number of data inputs for the SME to check/verify will also reduce during each iteration. Indeed, the verification quantity is not a fixed percentage or value, and the verification quantity is not selected ad hoc or arbitrarily. The SME may click Run (item 330) to start each iteration. Optionally, clicking the “Keywords Tool” for bulk labeling also runs another iteration as illustrated in FIG. 3N.

In FIG. 3H, the SME may click “Results look good” (item 335) when the SME is satisfied with the number of iterations (item 340), when the accuracy estimate of the current classification model (item 345) is satisfactory to the SME, or any combination thereof. The SME may be satisfied with the iterations, the accuracy estimate, or any combination thereof based on a threshold (e.g., accuracy estimate of 90 or greater, accuracy estimate of 85% or more, 90% or more, 85%-99.9%, 90%-99.99%, etc.), etc. FIG. 3M illustrates a different example having three iterations (item 350), a verification quantity of 32 (arrow 355) compared to 49 in the earlier example, and an accuracy estimate of 94% based on the 6% estimated error rate (item 360) for the current classification model in the different example.

Returning to FIG. 3H, after clicking “Results look good” (item 335), the SME may view the output of the complete dataset of 2150 data inputs with all corresponding SME labels and all corresponding predicted labels as illustrated in a spreadsheet in FIG. 3I. Optionally, as illustrated, the SME may select from the following three options: (a) Best Model Results option, (b) Machine Learning Model option, or (c) Abandoned Samples option. In FIGS. 3J, 3K, and 3L, clicking “Best Model Results” (item 365) generates an output of the complete dataset of 2150 samples with all corresponding SME labels and all corresponding predicted labels (e.g., in a spreadsheet such as FIG. 3I). In FIGS. 3J, 3K, and 3L, clicking “Machine Learning Model” (item 370) outputs a binary file corresponding to the machine learning classification model. In FIGS. 3J, 3K, and 3L, clicking “Abandoned Samples” (item 375) outputs a list of the data input labeled as “outlier” (e.g., in a spreadsheet).

EXAMPLE 2: FIGS. 4A-4J illustrate another embodiment of a tool for labeling an unlabeled dataset. In FIG. 4A, a labeled dataset, which includes a plurality of data inputs labeled by the SME, and the unlabeled dataset may be added to the tool. In FIGS. 4B-4D, clicking “Run Workflow” starts the workflow to train a classification model using the labeled dataset and determine a verification quantity. FIG. 4D illustrates that 2139 data inputs (illustrated as Total samples) were loaded, and 1838 of those data inputs were labeled by the SME (illustrated as Labeled) and 301 of those data inputs were unlabeled (illustrated as Unlabeled). CNN was utilized to generate this classification model using the 1838 labeled dataset. The classification model was used to generate the predicted labels (illustrated in the Prediction column) in FIG. 4E. The verification quantity is 50 and the tool will illustrate 50 unlabeled data inputs with their predicted labels and confidence levels for the SME to verify. The 50 data inputs are generally illustrated towards the bottom of FIG. 4E. The verification quantity of 50 was determined using AQL.

In FIGS. 4F-4G, the SME may click “Run Workflow” after verifying the 50 data inputs to start another iteration. The verification quantity will reduce during each iteration, and likewise, the number of data inputs for the SME to check/verify will also reduce during each iteration. Indeed, the verification quantity is not a fixed percentage or value, and the verification quantity is not selected ad hoc or arbitrarily. After clicking “Run Workflow”, FIG. 4H illustrates the third iteration, the verification quantity of 32, and the estimated Error Rate of 1% for the current classification model. FIG. 4I illustrates 32 unlabeled data inputs with their predicted labels and confidence levels for the SME to verify. In FIG. 4J, the SME may click “Best Model Results” (item 365) to generate an output of the complete dataset of 2139 samples with all corresponding SME labels and all corresponding predicted labels.

EXAMPLE 3: In another example, at least 15 samples per class/label may be utilized and there are at least two classes/labels. There may be about 10,000 samples that are not labeled by the SME (thus they are referred to as unlabeled) and a trained machine learning classification model may be applied to generate a predicted label for each of the 10,000 samples. The verification quantity may be determined to be 253 samples and the SME should verify the corresponding predicted labels for 253 samples out of the 10,000 unlabeled samples. Assuming the SME corrects the predicted label for 18 of the 253 samples, the SME can update/rebuild the machine learning classification model after correcting the 18 predicted labels. The estimate of accuracy of the updated machine learning classification model is determined by (1) actual model accuracy after rebuilding/updating and (2) estimated error rate by the AQL algorithm. Actual model accuracy is calculated by error items/total items. Estimated error rate by AQL is determined by looking up a table designed for AQL, such as the Table 2 with the title Sampling & Acceptance Limits at https://qualityinspection.org/what-is-the-aql/, which is incorporate by reference. Table 2 is utilized to determine the verification quantity and for estimating accuracy of the updated classification model.

If the SME is satisfied with the updated machine learning classification model's accuracy estimate, then the updated machine learning model may be utilized to predict labels and confidence levels for the remainder of the 10,000 samples (minus the 253 samples already verified). The updated machine learning model may also be utilized to label one or more other unlabeled datasets.

If the SME is not satisfied with the updated machine learning classification model's accuracy estimate, then the process may include iterating at least one of (d), (e), (f), (g), (h), or any combination thereof such that the updated machine learning classification model may be improved (and a new verification quantity may be determined, the SME may verify more predicted labels based on the new verification quantity, etc.). Multiple iterations may be carried out, such as more than 3 iterations, 3-10 iterations, 3-15 iterations, etc., such as discussed in Test 1-2. The final machine learning classification model may also be utilized to label the remainder and/or to label one or more other unlabeled datasets.

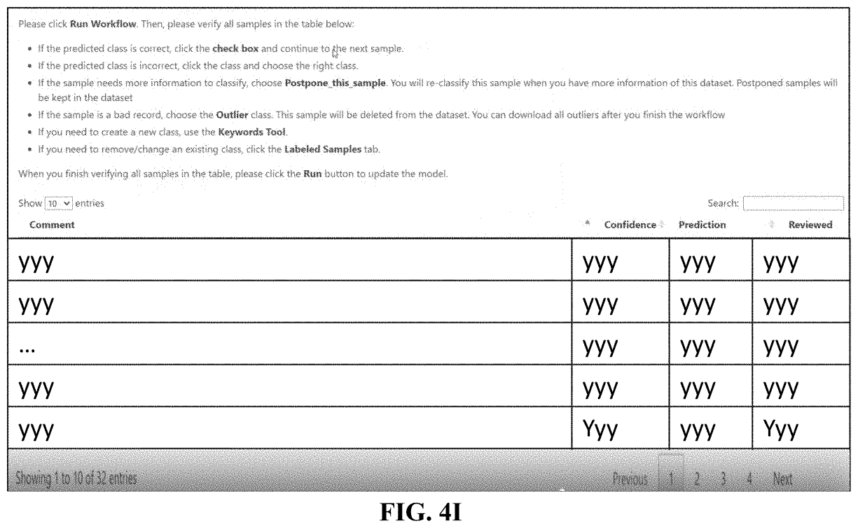

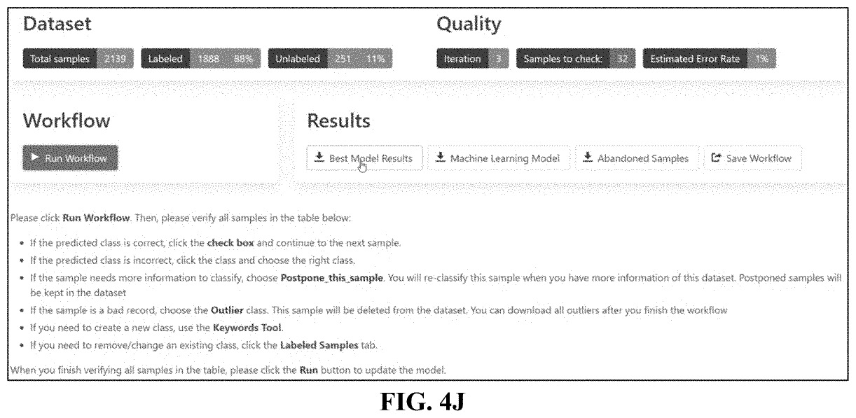

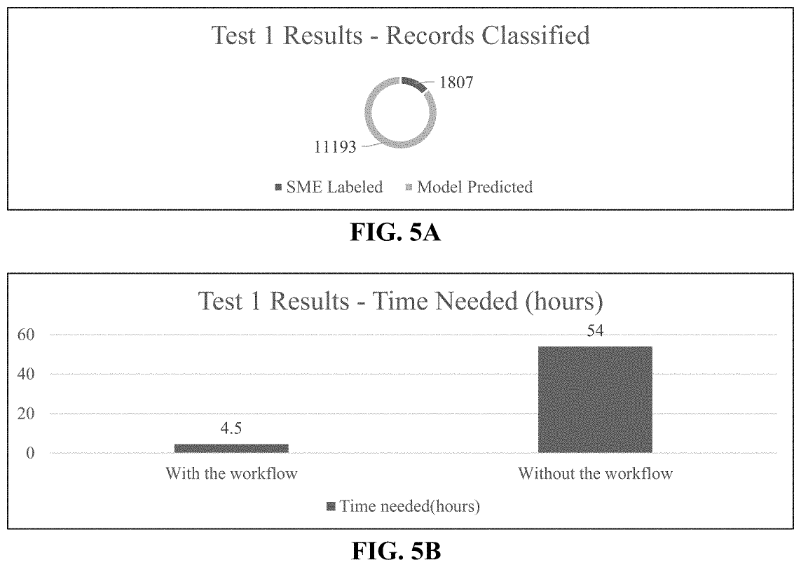

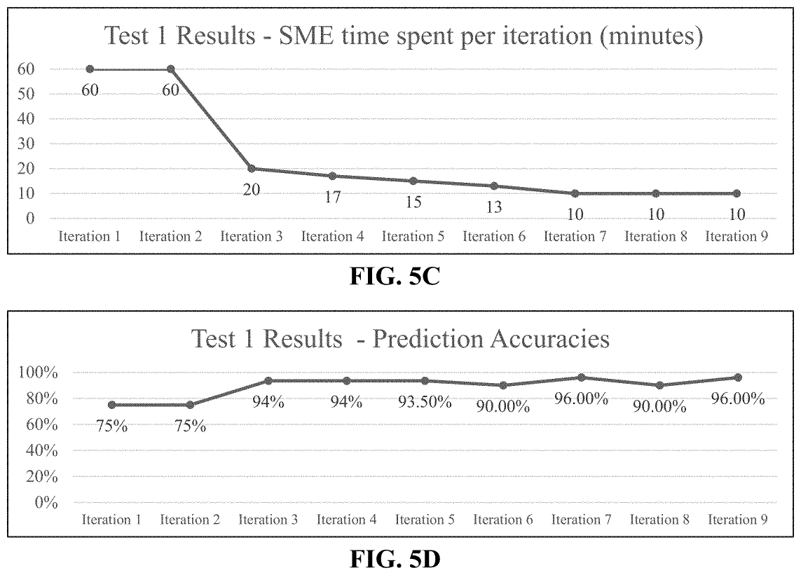

EXAMPLE 4: Test 1 corresponds to FIGS. 5A-5D. Test 1 involved classification of 13,000 events using a workflow as discussed herein with nine iterations. One SME labeled 1,807 events of those 13,000 events and the model predicted the labels for 11,193 events of those 13,000 events. The SME time needed in hours to label those 13,000 events was approximately 4.5 SME hours with the workflow, but it would have taken approximately 54 SME hours without the workflow. For example, SME time spent per iteration dropped from 60 minutes to 10 minutes throughout the nine iterations. Prediction accuracies by the model also increased from 75% to 96% throughout the nine iterations.

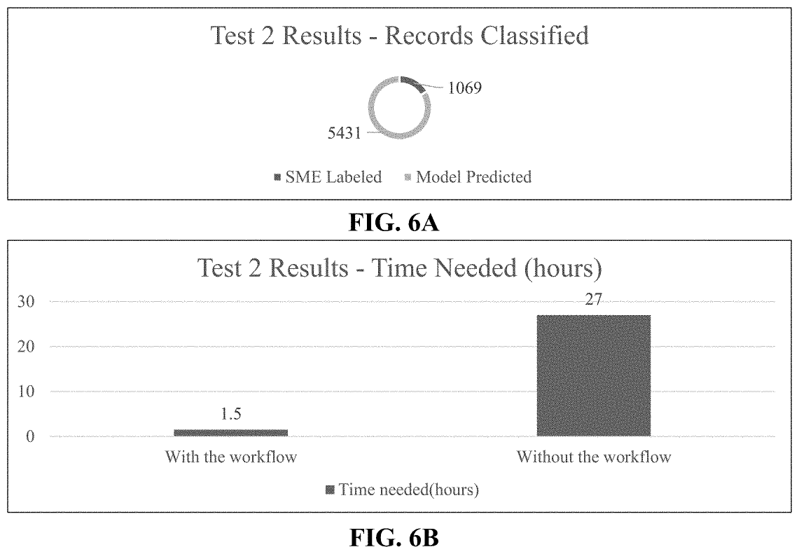

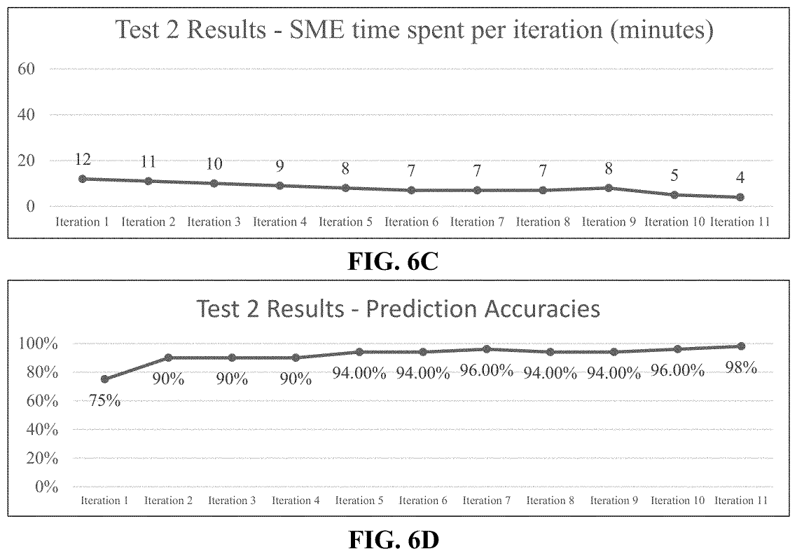

EXAMPLE 5: Test 2 corresponds to FIGS. 6A-6D. Test 2 involved classification of 6,500 events using a workflow as discussed herein with eleven iterations. One SME labeled 1,069 events of those 6,500 events and the model predicted the labels for 5,431 events of those 6,500 events. The SME time needed in hours to label those 6,500 events was approximately 1.5 SME hours with the workflow, but it would have taken approximately 27 SME hours without the workflow. For example, SME time spent per iteration dropped from 12 minutes to 4 minutes throughout the eleven iterations. Prediction accuracies by the model also increased from 75% to 98% throughout the eleven iterations.

EXAMPLE 6: Test 3 involved classification of 2,000 events using a workflow as discussed herein. The conventional process included the following steps: (i) request received for data (often with very short turn-around time required), (ii) the SME pulls as much as a year's worth of data from internal databases (e.g., hundreds of records), (iii) the SME manually categorizes the data, (iv) because of time constraints, categorizations are often broad and may not lend themselves to analysis or actionable mitigation, and (v) entries may also be prone to manual error due to the large volume of records and rushed time constraint. Categorization is dependent on SME experience and is potentially inconsistent between SMEs. Moreover, manually reading and analyzing hundreds (or even thousands) of records is an intensive manual process.

However, Test 3 was performed in a manner consistent with the present disclosure and included the following steps: (a) the SME categorizes a percentage of records for initial training of the model and this exercise involved a few hundred records, (b) the model is trained using those records, (c) the model categorizes remaining records, and (d) the SME reviews the classification, and if necessary, the SME would edit inaccurate classifications and rerun the model iteratively as needed—each time requiring less and less manual input. As the model evolves, fewer and fewer records will require manual classification by the SME.

Approximately 54% of the 2000 combined A and B dataset were either categorized manually by the SME or using a tool consistent with the principles of the present disclosure in close collaboration with the data scientist as the model was trained. The A dataset was annotated over the course of 16 workings sessions between the SME and data scientist ranging from 30 minutes to 2 hours. Once trained with A data, the tool classified quarter1 and quarter2 of the B data with an accuracy of 90%. Where the SME may have spent 10 or more hours classifying records manually before, classification for the same number of records was completed in approximately 30 minutes, which reduced workflow time by 80%.

Those of ordinary skill in the art may appreciate that the SME now has the time and the granular data to perform more effective data analysis—a much better use of SME's time. More granular categorization is now possible (e.g., more granular subcategories and/or actionable subcategories), lending itself to more meaningful analysis through near real time dashboards or predictive modeling. For example, categories may be broken down into more descriptive terms that may enable actionable analysis. The tool may also provide expedited insight into data to help enforce safeguards and used for other types of events such as process safety, etc.

Additionally, the SME can also improve the model as fresh records come in (some of which may have new classifications) making the model more robust. As multiple SME use the tool, the model also benefits from multiple and varied experience levels generating a more standardized output. The tool also allows SMEs to improve the model independently with less reliance on the data scientist using a user-friendly interface. To enable near time reporting, this process may even be hosted in the cloud so that data is continuously fed to the model for automated categorization with occasional fine tuning by one or more SMEs.

Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the technology disclosed herein. Also, a multitude of different constituent component names other than those depicted herein can be applied to the various partitions.

Additionally, regarding flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the components or functionality described or claimed as part of the component are all configured in a common package. Indeed, any or all of the various components of a component, whether control logic or other components, can be combined in a single package or separately maintained and can be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A method for labeling an unlabeled dataset, the method comprising:
(a) obtaining a labeled dataset comprising a first plurality of data inputs and corresponding labels;
(b) training a classification model using the labeled dataset;
(c) obtaining the unlabeled dataset comprising a second plurality of data inputs without corresponding labels;
(d) applying the classification model to the unlabeled dataset to generate a predicted label for each data input of the unlabeled dataset;
(e) determining a verification quantity of the predicted labels to be verified by a user;
(f) obtaining a verification dataset for the determined verification quantity of the predicted labels verified by the user, wherein the verification dataset comprises an update to at least one predicted label generated by the classification model;
(g) updating the classification model using the verification dataset; and
(h) applying the updated classification model to the remaining predicted labels that did not undergo verification and updating the remaining predicted labels in response to the updated classification model.

2. The method of claim 1, further comprising using an Acceptance Quality Limit (AQL) algorithm to determine the verification quantity of the predicted labels to be verified by the user.

3. The method of claim 1, further comprising displaying a visual representation of the determined verification quantity of the predicted labels and corresponding data input of the unlabeled dataset via a graphical user interface for verification.

4. The method of claim 1, further comprising:
generating a confidence level for each of the predicted labels;
displaying a visual representation of at least a portion of the generated confidence levels via a graphical user interface; or
any combination thereof.

5. The method of claim 1, further comprising:
determining an accuracy estimate of the updated classification model;
displaying a visual representation of the accuracy estimate of the updated classification model via a graphical user interface; or
any combination thereof.

6. The method of claim 5, further comprising:
comparing the accuracy estimate for the updated classification model with an accuracy threshold; and
iterating at least one of (e), (f), (g), (h), or any combination thereof in response to a comparison of the accuracy estimate of the updated classification model and the accuracy threshold.

7. The method of claim 1, further comprising iterating at least one of (e), (f), (g), (h), or any combination thereof in response to obtaining user input that initiates an iteration.

8. The method of claim 1, further comprising iterating at least one of (e), (f), (g), (h), or any combination thereof in response to obtaining a keyword for bulk labeling.

9. The method of claim 1, wherein the classification model comprises a machine learning algorithm.

10. The method of claim 9, wherein the machine learning algorithm comprises a convolutional neural network, a long short-term memory network, a fully connected network, or any combination thereof.

11. A system for labeling an unlabeled dataset, the system comprising:
a processor and a non-transitory computer readable medium with computer executable instructions embedded thereon, the computer executable instructions configured to cause the processor to:
(a) obtain a labeled dataset comprising a first plurality of data inputs and corresponding labels;
(b) train a classification model using the labeled dataset;
(c) obtain the unlabeled dataset comprising a second plurality of data inputs without corresponding labels;
(d) apply the classification model to the unlabeled dataset to generate a predicted label for each data input of the unlabeled dataset;
(e) determine a verification quantity of the predicted labels to be verified by a user;
(f) obtain a verification dataset for the determined verification quantity of the predicted labels verified by the user, wherein the verification dataset comprises an update to at least one predicted label generated by the classification model;
(g) update the classification model using the verification dataset; and
(h) apply the updated classification model to the remaining predicted labels that did not undergo verification and update the remaining predicted labels in response to the updated classification model.

12. The system of claim 11, wherein the computer executable instructions are configured to cause the processor to use an Acceptance Quality Limit (AQL) algorithm to determine the verification quantity of the predicted labels to be verified by the user.

13. The system of claim 11, further comprising displaying a visual representation of the determined verification quantity of the predicted labels and corresponding data input of the unlabeled dataset via a graphical user interface for verification.

14. The system of claim 11, further comprising:
determining an accuracy estimate of the updated classification model;
displaying a visual representation of the accuracy estimate of the updated classification model via a graphical user interface; or
any combination thereof.

15. The system of claim 14, further comprising:
comparing the accuracy estimate for the updated classification model with an accuracy threshold; and
iterating at least one of (e), (f), (g), (h), or any combination thereof in response to a comparison of the accuracy estimate of the updated classification model and the accuracy threshold.

16. The system of claim 11, further comprising iterating at least one of (e), (f), (g), (h), or any combination thereof in response to obtaining user input that initiates an iteration.

17. The system of claim 11, further comprising iterating at least one of (e), (f), (g), (h), or any combination thereof in response to obtaining a keyword for bulk labeling.

18. The system of claim 11, wherein the classification model comprises a machine learning algorithm.

19. The system of claim 18, wherein the machine learning algorithm comprises a convolutional neural network, a long short-term memory network, a fully connected network, or any combination thereof.

20. A non-transitory computer readable medium storing one or more programs, the one or more programs comprising instructions, which when executed by an electronic device with one or more processors and memory, cause the device to:
(a) obtain a labeled dataset comprising a first plurality of data inputs and corresponding labels;
(b) train a classification model using the labeled dataset;
(c) obtain the unlabeled dataset comprising a second plurality of data inputs without corresponding labels;
(d) apply the classification model to the unlabeled dataset to generate a predicted label for each data input of the unlabeled dataset;
(e) determine a verification quantity of the predicted labels to be verified by a user;
(f) obtain a verification dataset for the determined verification quantity of the predicted labels verified by the user, wherein the verification dataset comprises an update to at least one predicted label generated by the classification model;
(g) update the classification model using the verification dataset; and
(h) apply the updated classification model to the remaining predicted labels that did not undergo verification and update the remaining predicted labels in response to the updated classification model.
